(19) United States
(12) Patent Application Publication
(10) Pub. No.: US 2006/0077941 A1
(43) Pub. Date: Apr. 13, 2006

(54) User interface system and method for implementation on multiple types of clients

(76) Inventors: Meyyappan Alagappan, Sunnyvale, CA (US); Stephen Paul Paddon, Portland, OR (US); Thomas Sherwin Paddon, Brisbane, CA (US); Alexander Flavio Panelli, Palo Alto, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/151,798

(22) Filed: Jun. 13, 2005

Related U.S. Application Data
(63) Continuation-in-part of application No. 10/963,929, filed on Oct. 12, 2004.
(60) Provisional application No. 60/611,353, filed on Sep. 20, 2004.

(51) Int. Cl. H04Q 7/24

(52) U.S. Cl. 370/338

(57) ABSTRACT

A method and system for implementing a user interface for providing a data service in a mobile client using a server with knowledge of the client's hardware and software capabilities to modify data content and display rules for an improved user interface on the client. Data may be cached on the client to improve application response time and provide a standalone application capability for the client. The automatic conversion of newly developed applications to a plurality of clients with differing hardware and software capabilities reduces application software development and maintenance costs. Software updates and bug fixes can be deployed with the same method and system.

### CROSS-REFERENCE TO RELATED APPLICATIONS

This application is a continuation in part of U.S. patent application Ser. No. 10/963,929, filed on Oct. 12, 2004, entitled “SYSTEM AND METHOD FOR DEVELOPING AND DEPLOYING DEVICE INDEPENDENT APPLICATIONS” which is hereby incorporated herein in its entirety by reference. This application takes priority from U.S. application No. 60/611,353, filed on Sep. 20, 2004 entitled “SYSTEM AND METHOD FOR DEVELOPING AND DEPLOYING DEVICE INDEPENDENT APPLICATIONS” which is hereby incorporated herein by reference.

### TECHNICAL FIELD

This invention relates to user interfaces for applications for clients in client-server computer systems. More particularly, but not by way of limitation, this invention enables the implementation of user interfaces for a plurality of server-based applications on a plurality of client types with fast performance and reduced upfront development time.

### BACKGROUND ART

Client-server computing systems typically use servers to provide services to a client. The client is often smaller, less capable, less expensive, and more mobile than an associated server. One server usually provides services to multiple clients, whereas a client can often obtain services from multiple servers. The communication link between a client and a server may be of any appropriate type, including wired or wireless. In particular, wireless clients offer the opportunity for tether-free mobility, and usually have self-contained power sources such as batteries. Communication bandwidth is usually restricted more for a wireless connection than it is for a cabled connection. Moreover, providing batteries for suitable client operating time constrains the power that can be consumed by the client. In the interest of providing more mobility and greater battery lifetimes for clients, it is important to reduce the computational burden required of clients to perform their functions. Such minimal clients are sometimes referred to as “thin clients.” A thin client for wireless use is often implemented to reduce memory and processor requirements for reduced power consumption, size, and cost—while at the same time, conserving wireless communication bandwidth for communication with a server or other devices over a communication channel (often wireless).

The term mobile data communication device can refer to a wireless communication device that provides access to wireless data services when in communication with a server. Examples of such devices include “smart” cell phones, wireless enabled notebook computers or PDAs, alphanumeric pagers, and many others that are limited only by the imagination. Over the past several years, wireless data services have proliferated more and more among mobile communication device users, especially, for example “smart” cell phone users. Popular wireless data services for cell phone users currently include, among others, e-mail exchange (including graphics), short message service, internet browsing, and paid mobile access to databases. Emerging services further include, position location based services, wireless advertising, wireless “e-community” services—to name a few—with the list being constantly expanded. Expanding the user popularity and commercial potential of wireless data services generally depends on their widespread deployment with minimal development, deployment, and operating costs.

An aspect of the rapidly evolving field of wireless data services that hinders widespread deployment and development cost reduction, is the plurality of software platform standards for clients (sometimes referred to as “real time operating systems,” or “RTOS”s), and the diversity of hardware and user interface capabilities for wireless terminals serving as clients. Cell phone service providers, for example, often endeavor to support cell phones from manufacturers espousing different software platform standards such as WAP (the “Wireless Applications Protocol” standard), J2ME (a mobile version of Java®), BREW (from QUALCOMM, Inc.), and others. Wireless data enabled PDA manufacturers often alternatively use software platforms such as Palm OS® (from Palm Computing, Inc.), Windows CE® and Windows Handheld® (both from Microsoft, Inc.), and Symbian® (a European standard), among others. Additionally, devices for user data input, and visual displays can vary greatly in capabilities from product to product. Devices for user data input include keyboards ranging from augmented phone dial pads to full QWERTY (also called ASCII herein) keyboards, as well as others such as touch screens. Displays can be monochrome or color, of various resolutions and aspect ratios, different character set capabilities, different vector graphics capabilities, and different levels of grayscale or color depth as expressed in bits.

Although the standard software platforms described above were created to facilitate device independent client applications, the incompatibility problem largely remains in that there are multiple standards and multiple devices. Hence, applications cannot be created for only one standard or hardware device given the diversity of software standards and user interface hardware options for the range of mobile communication devices to be provided with wireless data service. For example, client application software to run on two different manufacturers' phones might need to be written in both BREW® (for a first manufacturer's phone) and J2ME (for a second manufacturer's phone). Further aggravating the software development problem is the fact that the first manufacturer, for example, may provide mobile communication devices with a number of different options for display sizes, further requiring additional versions of software.

Deploying one application to multiple platforms can require that software developers write multiple client applications where each application is specific to a particular platform. This is the case even though the functionality of the application and often the interface itself is intended to be the same regardless of the underlying software platform or user interface hardware. Thus wireless data application developers often invest significant time and resources in developing and maintaining applications that are platform, and often device, specific. When a program error is discovered in one version of an application, the error must often be fixed in other platform and/or device dependent versions of the same application, and then deployed separately to multiple server systems. Each time an application is ported to a new application environment, a team of developers is required to invest their time and energy in developing, maintaining, and upgrading the software. It is not uncommon for companies to employ completely separate teams of developers to develop and maintain these different versions of the same application. Consequently, a significant waste of resources can be incurred as a result of current application development methods for wireless data applications. And this problem is not limited to wireless data service environments, but can arise in other data service environments where it is desirable to deploy client-server applications that accommodate many types of clients.

### DISCLOSURE OF THE INVENTION

The current invention provides a method and system for implementing a user interface for providing a data service in a mobile client using a server with knowledge of the client's hardware and software capabilities (hereinafter referred to jointly as “device characteristics”) to modify data content and display rules for an improved user interface on the client. Data may be cached on the client to improve application response time and to provide standalone application capabilities for the client. The automatic conversion of newly developed applications for a plurality of clients with differing client device characteristics reduces application software development and maintenance costs. Software updates and bug fixes for previously deployed applications can be deployed to mobile communication devices using the same method and system, through data downloads when a client device accesses an application.

### BRIEF DESCRIPTION OF THE DRAWINGS

FIG. 1 is a block diagram illustrating an overview of an exemplary wireless network in accordance with one embodiment of the present invention.

FIG. 2 illustrates display pages of a exemplary mobile application in another embodiment of the invention.

FIG. 3 is a diagram illustrating a high level view of a wireless data service being deployed to a client in accordance with one embodiment of the invention.

FIG. 4 illustrates an application server in accordance with one embodiment of the invention.

FIG. 5 is a flowchart describing server processing in accordance with an embodiment of the invention.

FIG. 6 illustrates a client in accordance with another embodiment of the invention.

FIG. 7 is a flowchart illustrating client processing in accordance with one embodiment of the invention.

FIG. 8 is a flowchart showing client processing in accordance with another embodiment of the invention.

FIG. 9 is a flowchart showing client processing in accordance with a further embodiment of the invention.

FIG. 10 is a flowchart illustrating an operation of a content adapter in accordance with an embodiment of the invention.

FIG. 11 is a flowchart showing the development of an application in accordance with an embodiment of the invention.

FIG. 12 illustrates an exemplary client display screen for an exemplary application in a further embodiment of the invention.

FIG. 13 illustrates a computer display screen of an application development tool in an embodiment of the invention.

FIG. 14 illustrates another computer display screen of an application development tool in an embodiment of the invention.

FIG. 15 illustrates an exemplary hardware architecture of a server in an embodiment of the invention.

FIG. 16 illustrates an exemplary hardware architecture of a client in another embodiment of the invention.

### MODES OF CARRYING OUT THE INVENTION

One embodiment of the present invention is directed toward a novel system and method to enable software developers for a client-server environment to efficiently develop, deploy, and maintain an instance of an application that can be configured to operate on different types of client devices, including mobile communication devices such as mobile phones, smart phones, personal digital assistants, and two-way paging systems. In accordance with one embodiment of the present invention, developers are provided with the tools and features to develop and deploy applications that are, at least to some extent, device independent. In one or more implementations, these goals can be accomplished with little or no modification to existing infrastructure and without a need for a manufacturer's modification of client devices.

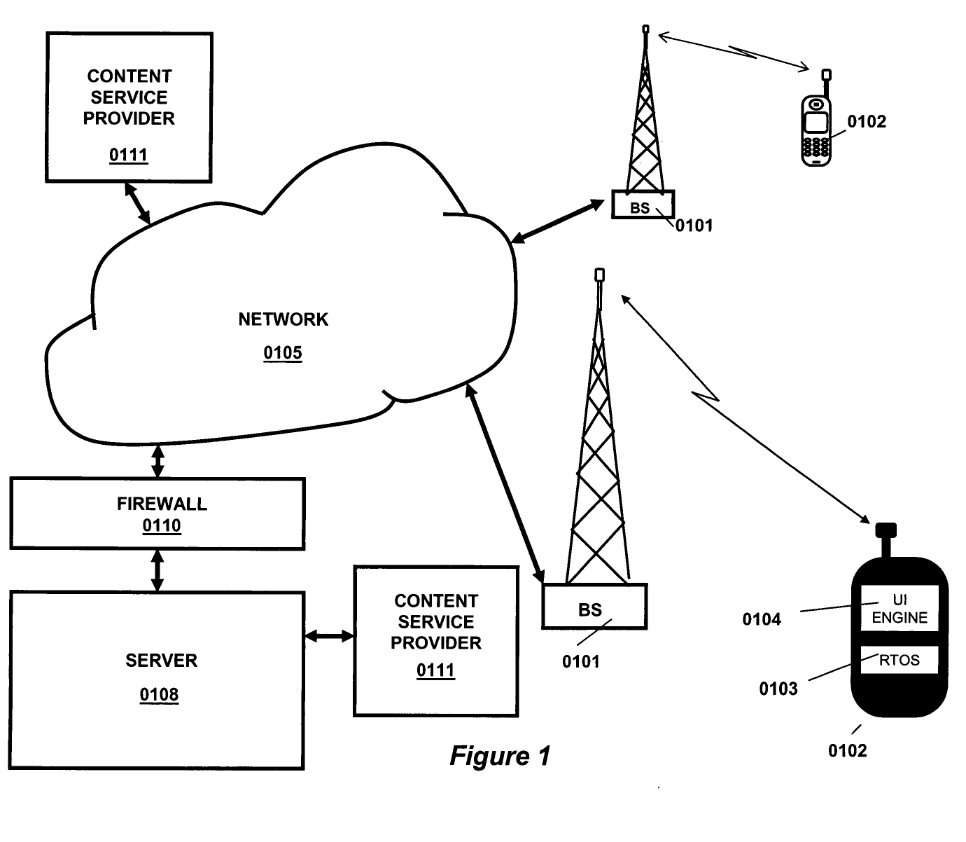

Before describing the invention in detail, it is useful to describe an example environment in which the invention can be implemented. The example environment described is that of a wireless communication network. More particularly, the example environment described is a wireless communication network configured to provide wireless data services to one or more network users. FIG. 1 is a block diagram illustrating an overview of this example wireless network in accordance with one embodiment of the present invention. The illustrated wireless network includes one or more mobile communication devices 0102, one or more mobile base stations 0101, and a communication network 0105. Also illustrated are a server 0108, a firewall 0110, and content service providers 0111, which can be included to interface to the wireless communication network in accordance with one embodiment of the invention.

In one implementation of the example environment illustrated in FIG. 1, the clients, in this example mobile communication devices 0102, can be implemented as smart phones, which can be implemented as a wireless phone (for example, a cellular telephone) with data features. For ease of description and to illustrate various features, the invention is from time to time described herein in terms of clients implemented as smart phones 0102. However, after reading this description it will become apparent to one of ordinary skill in the art how to implement the various features and functions of the invention with other mobile communication devices and with other client devices in general.

In operation, mobile communication devices 0102 are in wireless communication with one or more base stations 0101. A base station 0101 may be implemented as a conventional cellular telephone base station, or another type of relay or base station such as, for example, a wireless access point in a wireless local area network. In this and other environments other devices may be utilized to allow a client to access a server such as, for example, a router or gateway or other like device.

In a conventional cellular network, base stations 0101 can in certain implementations be described as having three components. The cell sites, which are often referred to as base transceiver stations or BTS's, communicate directly with the mobile communication devices 0102. Base station controllers or BSC's (not shown) control the base transceiver stations either over land links (typically) or over radio links. Mobile switching centers or MSC's (not shown), often called mobile telephone switching offices, control the base station controllers, usually over land links. There is no fixed ratio of BTS to BSC to MSC, required, and these base station functions may be combined into a single site. Often cellular phone systems, and other wireless mobile data systems, have multiple base stations 0101. This provides for data communication service handoff from one base station to another as a mobile data terminal roves among the base stations' respective coverage areas.

Smart phones 0102 can be implemented utilizing one or more of several types of real time operating systems (RTOS) 0103 running on an internal processor such as, for example a baseband or other processor (also referred to as “microprocessor” or “microcontroller”). operating system 0103 can interface applications running on the internal digital processor with hardware operably connected with the processor, such as, for example, a radio frequency (RF) modem, a keypad, a visual display, baseband, mixed-signal and analog circuitry, and others. Various smart phones 0102 can be implemented using various different configurations of hardware and software, including, for example, different types or versions of operating systems 0103 and different configurations of user interfaces (for example, keypads and displays).

In FIG. 1, each of two base stations 0101 is illustrated as being in wireless connection with a respective one of two mobile communication devices 0102. Because base stations 0101 are connected via network 0105 in FIG. 1, mobile communication devices 0102 can communicate with one another through the base stations 0101 and network 0105, or sometimes directly. Of course additional base stations 0101 and additional mobile communication devices 0102 (and various alternatives of either) can be eliminated, substituted, or added as well.

Network 0105 may be implemented as any type or combination of types of communication network, including local area and wide area networks of varying configurations and protocols. For example, base stations 0101 are sometimes connected using the asynchronous transfer mode (ATM) standard protocol. Often, at least a part of network 0105 may be implanted with an Internet Protocol (IP v.4 or IP v.6) protocol. In some environments, such as the cellular environment, for example, the cellular network is designed to connect to the existing phone system, also called the Public Switched Telephone Network or PSTN (not illustrated), or to other data network voice or data networks. The connection to the PSTN is similar to the connection of other telephone switching equipment such as a Public Branch Exchange (PBX).

In the example environment illustrated in FIG. 1, one or more mobile communication devices 0102 can include a UI engine 0104 that can be implemented as an application that is interfaced with, or running “on top of,” operating system 0103 in a mobile communication device 0102. In can also be implemented in various other software embodiments, or as hardware, firmware, or other logical components. In an embodiment of the present invention, UI engine 0104 can be implemented so as to improve the user interface performance for wireless data applications.

Also illustrated in the example environment of FIG. 1 are content service providers 0111. One or more content service providers 0111 can interface with the wireless communication network to provide one or more items of content to network users. For example, with increasing capabilities of contemporary mobile communication terminals 0102, various content items such as games, ring tones, screen savers, photographs, movies, and other applications and content items (generally referred to herein as “content”) are often made available to users for download onto clients such as mobile communication devices 0102. As illustrated, content service providers 0111 can be connected to network 0105 in various different ways to enable downloading of content to the clients 0102.

In addition to downloading content via the wireless link, content can be downloaded to the mobile communication device 0102 using other means such as, for example a direct connection. One example of a direct connection can be a synchronization operation between the mobile communication device 0102 and a user's personal computer where the content was previously downloaded to or otherwise resides on the computer and is subsequently downloaded to the mobile communication device 0102 during a synchronization or other operation. After reading this description it will become apparent to one of ordinary skill how other content delivery mechanisms can be implemented.

In the present invention, server 0108 can be implemented so as to support applications for UI engine 0104 on clients 0102. In one embodiment, this can be accomplished by retrieving application content from service providers 0111 and processing content. One or more content service providers 0111 can be in communicative contact with the example environment. They can access network 0105 and one or more servers 0108 in a number of different ways. For example, a content service provider 0111 may have a connection to server 0108 other than through the network 0105. Additionally, a content service provider 0111 may be in communicative contact with a server 0108 via network 0105. Although content service provider 0111 is illustrated as being somewhat directly connected to network 0105, other communication channels, connections or interface techniques can be provided to allow communication between content service provider 0111 and server 0108.

Content service provider 0111 provides data services to clients 0102. Content services providers 0111 are often implemented as servers, and can use similar hardware and operating system software to server 0108. Types of data services are too numerous to list, but can include, for example: news, weather, driving directions, horoscope, stock quotes, hotel and restaurant information, etc. In addition to these information services type of data services, content service providers 0111 can also provide other content to one or more clients 0102 such as, for example, applications and application programs, media content, software plug-ins and modules, games and gaming applications suitable for running on a client device 0102, and other forms of content or other information that may be useful or of interest to the user with his or her client device 0102. Thus, as used in this document, the term “content” is used to refer to any of a number of different forms of information, data, application, media or other content that may be provided from a content service provider 0111 to a client device such as a mobile communication device 0102. This content can be in various forms and include one or more of a plurality of different data or information types including, for example, software or other code, graphics, textual information, audio information, image information, and video information.

Having thus described an example environment in which the present invention can be applied, the present invention will now be described in greater detail in terms of this example environment. After reading this description, it will become apparent to one of ordinary skill in the art how to implement the invention in its various forms and embodiments in this or alternative environments in which it may be desirable to utilize the features and aspects of the present invention.

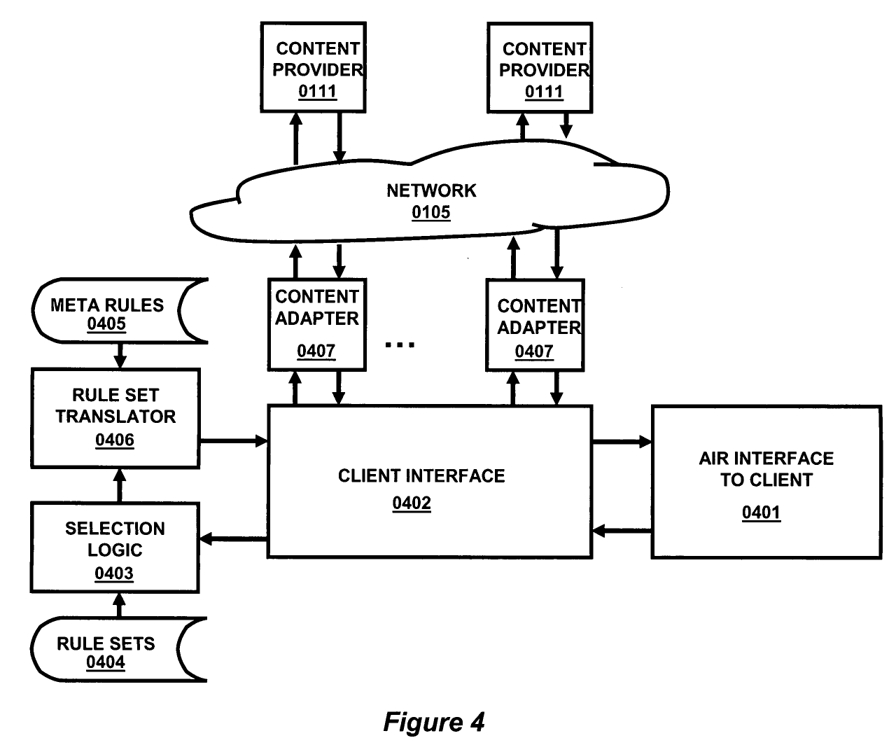

When a user determines that he or she desires to obtain content for his or her mobile communication device 0102, one technique for carrying out these wishes is to identify the content (for example, a particular application) and to indicate a request for the content such as, for example, by entering appropriate keystrokes or other inputs to request a download of the content. Upon receiving a user request, UI Engine 0104, in one embodiment transmits an event to a server 0108 communicatively connected to the network. The event, in one embodiment includes device characteristics about the requesting device and the content. These device characteristics can include, for example, information such as an identification of the requested content along with other useful information such as, for example, information to identify the mobile communication device 0102 for which the request is made. For example, the event may include an identification of the brand, model, type or class of mobile communication device 0102 for which the content is being requested. Additional examples of device characteristics are provided below. Upon receipt, a rule set is appropriately applied to the content based on device characteristics from the requesting client device 0102 (e.g., device type, class, brand, model, carrier, application, application state, and so on), thus formatting or otherwise preparing the content for execution on the mobile communication device 0102. This process of combining a rule set with content is described in greater detail below with reference to FIG. 4.

When a user downloads content to mobile communication device 0102, one embodiment of the invention provides the capability to download a UI Engine 0104 configured for the specific mobile communication device 0102 or class of mobile communication device 0102. In one embodiment, this can be downloaded transparently before a first component of the application (for example a splash screen) is downloaded. Thus, a UI Engine 0104 can be prepared and downloaded to the client device 0102 for the particular content item requested. As such, one or more UI Engines 0104 may be installed and running on a given client device 0102 in this particular embodiment. Thus, for example, it is not necessary that a given UI Engine 0104 perform any or all of the functionality that may be traditionally or conventionally associated with UI Engines 0104 in implementations of client devices 0102 such as, for example, mobile communication devices 0102. As such, the term “UI Engine” should not be construed as limited to a conventional or traditional UI Engine.

Mobile communication device 0102 can be configured so as to execute UI Engine 0104 which, in one embodiment as mentioned above, is specific to that mobile communication device 0102, or to that class of devices to which mobile communication device 0102 belongs. In one embodiment, UI Engine 0104 can be created once per device and configured so as to be able execute various application interfaces. As such, in this embodiment, mobile communication device 0102 can perform specified functions by downloading a UI component that can include a rule set for the desired content item along with any associated content data or information.

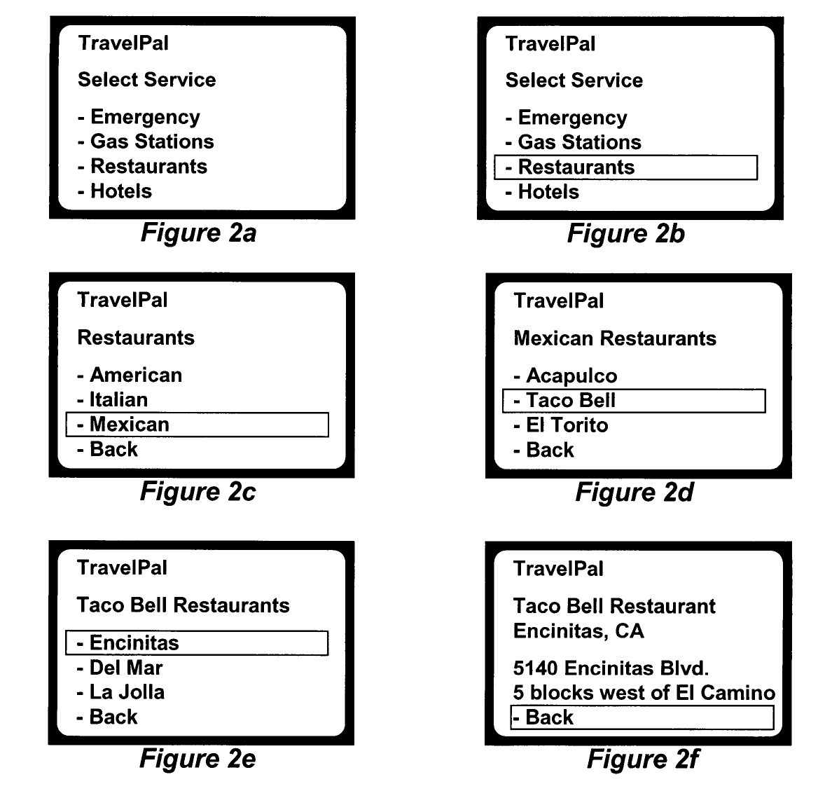

As stated above, in accordance with one embodiment of the invention, features and functionality can be provided to facilitate the development, deployment, and performance of content bearing applications to mobile communication device 0102 users. FIG. 2 illustrates exemplary application display pages as they could appear on a mobile communication device display in accordance with one embodiment of the invention. In this particular illustrated example, FIG. 2a shows an example initial display page for a hypothetical application (i.e., content) used to retrieve and provide information to a user of a mobile communication device 0102 in a number of different categories as listed on the exemplary screen shot. The categories shown in this example are emergency services, gas stations, restaurants, and hotels.

FIG. 2b shows an example of the screen in FIG. 2a, but with one of the categories, in this case “restaurants,” being highlighted. This selection can be made, for example, through a user actuation of an input device such as a keyboard, keypad, joystick, touchscreen, touchpad, mouse, voice command interpreter, or other user interface. This is generally referred to as a user input. Through an appropriate user input, the user selects the category for which he or she desires more information. For example, in the example illustrated in FIG. 2b, once the appropriate category is highlighted, a simple user action such as, for example, pressing an Enter key or other action via a user interface, can facilitate selection of the highlighted category. An event need not be selected by first highlighting a category as illustrated in the above example. Indeed, an event can be generated via a number of different user inputs including, for example, a direct selection of the desired category via the available user interface. In other embodiments, an event can also be generated by server action or via another device.

This selection generates an event that can be used to facilitate retrieval of additional content as specified by the event. Thus, in the example illustrated in FIG. 2b, when the user selects “restaurants” as the appropriate category, the event can be used to indicate to the application that additional information about the category of restaurants is requested by the user. As such, continuing with this example scenario, the example screen illustrated in FIG. 2c can be retrieved and displayed which, in this case, lists categories or types of restaurants from which the user may choose.

As mentioned above, the example display page illustrated in FIG. 2c shows a listing of the categories or types of restaurants about which additional information can be retrieved in the currently running application. As with the previous screen, the user can cause one of the categories to be selected, which results in an event, to facilitate retrieval of additional content. In the examples illustrated in FIG. 2c, the user highlighted the category “Mexican” for selection as the type of restaurant about which he or she desires additional information.

As a result of this event, additional information about Mexican restaurants is provided as illustrated by the example display of FIG. 2d. In this example of FIG. 2d, various categories of Mexican restaurants are provided which, in this example, are particular Mexican restaurants by name such as, for example, Acapulco, Taco Bell, El Torito, and so on.

As illustrated in FIG. 2d, a user input selects a category of Mexican restaurant that results in the display of FIG. 2e, which in this example is a selection of location cities for that category of Mexican restaurant. Selecting a location city results in information about a specific restaurant being displayed in FIG. 2f.

In this application example, each user input on the various screens selects or generates exit criteria for a display page that results in the loading of the next display page, that can be one of a plurality of possible next display pages. For example, if the user had selected the category “Italian” in FIG. 2c, the display of FIG. 2d could display categories of Italian, instead of Mexican, restaurants. Thus, one or more display pages can include exit criteria for the page, which can vary for the various selections or options associated with the page. The exit criteria can be used to generate the appropriate event to retrieve an appropriate next screen based on the user input.

Note that in this example, FIGS. 2b-2f also include “Back” as an option. The “Back” option allows users to recover from mistaken entries, or to back track through selections. Of course, other buttons or selections can be included depending on the application and depending on the application developer's wishes or goals in creating the application. For example, Home and End buttons can be provided as well as other action buttons, allowing exit criteria to be actuated and events to be generated.

As discussed above, in one embodiment, one or more of the content screens include exit criteria that are used to facilitate retrieval of a subsequent screen. For example, exit criteria can be included to provide information about an action to be taken or additional content to be retrieved or displayed based on a user input. Thus, for example, where multiple user selections are permitted, it may be appropriate to include different exit criteria for the various user selections such that appropriate action can be identified based on the user selection. Also, as described above, the invocation of exit criteria can result in the creation of an event that can be used to facilitate retrieval of additional content. For example, in one embodiment, the event can be sent to the server 0108 to indicate to the server that additional content has been requested and also to indicate the type or other specific information about the requested content.

As described in more detail below, in one embodiment, events do not necessarily need to be forwarded to a server such as, for example, server 0108 to retrieve additional content in response thereto. In one embodiment, as described in more detail below, one or more various content items can be cached locally or at some other location and the content retrieved from the cache rather than from a remote location.

Applications composed of display pages with exit criteria pointing to subsequent display pages can contain both static and dynamic content. Static content preferably does not change or at least does not change frequently with time. Static content may be loaded in an application executing on UI Engine 0104 of a mobile communication device 0102, and optionally updated on an infrequent basis, or never updated. In the hypothetical example of FIG. 2, an example of static content could include service categories or perhaps a splash screen or main menu. Dynamic content is content that generally goes out of date more frequently and is therefore typically periodically refreshed. Examples of this can include restaurant addresses, addition of new restaurants, changing phone numbers and so on. To provide another example, in a news service application, pages displaying various news items or advertisements may utilize frequent updates.

In accordance with one embodiment of the invention, application developers are provided with a method to create a content bearing mobile application consisting of an interrelated set of display pages consisting of static content and formatting (together, making a “rule set”) that can also be combined with dynamic content. In one embodiment, each display page has exit criteria that can point to, for example, a next display page, one of a plurality of next display pages, an application execution termination, or a branching to another application.

In one embodiment, the rule set comprises a set of application display pages. For example, in this embodiment, the rule set may include an introductory splash screen display page and can further include one or more subsequent display page(s) that can be “clicke” through by user input via either keypad entry, touchscreen entry, voice commands or other user interface command. Because the original event identified the type or class of mobile communication device 0102, this information can be used, for example to ensure that these screens are formatted properly for suitable display on the particular mobile communication device 0102.

When a user makes an input selecting further content (for example, selects an option from a menu screen) UI Engine 0104, in one embodiment, transmits another event to a server 0108 that is preferably communicatively connected to the network. The event, in one embodiment can include information such as an identification of the content and a screen identification, along with other useful information to identify the content and the mobile communication device 0102 for which the request is made.

Alternatively, in order to optimize or at least enhance the application appearance, it is possible to also generate rule sets based on device characteristics such as, for example, a resolution size for a device, font size, language preference, font type supported, an application identifier and an application state indicator that specifies the current state of the identified application as it runs on the mobile communication device, among others. This allows fine tuning of content parameters such as, for example, button sizes and label sizes, in order to take advantage of the mobile communication device-specific display or other characteristics. In one embodiment, the rule set may default to a standard rule set if no optimization has occurred for a characteristic of a given mobile communication device type.

This invention can be implemented in one embodiment to allow an application developer to develop and administer a data application for a mobile terminal that is subsequently compatible with multiple different clients without. The server can maintain a plurality of rule sets that are used to conform the content to the requesting device—it not exactly, then at least close enough to enable suitable performance. When new clients are added to the system, if needed, new rule sets can be added to better conform the application to one or more of the device characteristics corresponding to that type of client. Thus, multiple rule sets can be maintained for various sets of device characteristics to enable appropriate delivery of content. These rule sets are discussed in more detail below with reference to FIG. 4.

The server can also maintain or utilize data and instruction transformation rules, which are referred to as meta-rules. Meta rules, as also discussed below with reference to FIG. 4 can be used to conform rule sets to various devices or special conditions. Thus, a meta-rule in one embodiment can be thought of as a rule that modifies a rule set or the application of a rule set. As a result of rule sets and meta rules, the invention can be implemented in one embodiment so as to allow separation of tasks of developing and maintaining applications, from the tasks of preparing, optimizing or conforming applications for specific types for terminals.

Embodiments of the invention provide developers with the ability to develop and deploy client device independent applications that can ultimately be tailored to particular client device characteristics, either manually or automatically. In one embodiment, development is performed using a workflow. A workflow may be utilized in one embodiment as a sequence of application screens (referred to herein as display pages). The sequence of displays can be defined in terms of exit criteria used for the various screens. Transitioning from one screen to a next screen can be made so as to be contingent on events generated from user input or other action with exit criteria defining how to respond to a particular event. An event, for example, may be an item of data received by a first client device from a server, an item of data received from another client device, or a user interface actuation of the first client device.

A display page in one embodiment can be implemented as representing a set of data content and associated formatting instructions to generate a user interface display. In another embodiment, Display components sent to a client comprise device specific instructions to render an appropriate display (or provide other appropriate user interface functions) on a client.

In one embodiment, a display page may be defined as a display component that is built with lower level display components. Together, a set of one or more display components is herein referred to as a rule set. A rule set may be used to define various user interface features or other device specifications for providing the appropriately configured display page or pages to the client. For example, a rule set may define the audio or video display of information and formatting on a client, or how user information from a client is used and so on.

Thus a rule set a set of criteria for one or more display pages, assembled with their respective content as a template or with a placeholder for respective content to be added. Display pages can include exit criteria that specify, perhaps conditionally, information such as, for example, the next display page to be displayed. Additional exit criteria could include, for example, responses to warnings received from the server, or application termination responsive to receipt of an error message from a server.

In a further embodiment, workflows may include global data comprising visual display components that may be common to more than one display page in an application, or even to more than one application. Examples of global data may include various cached messages or images, some or all of which can be cached to speed the execution of a client application, while minimizing client device memory requirements.

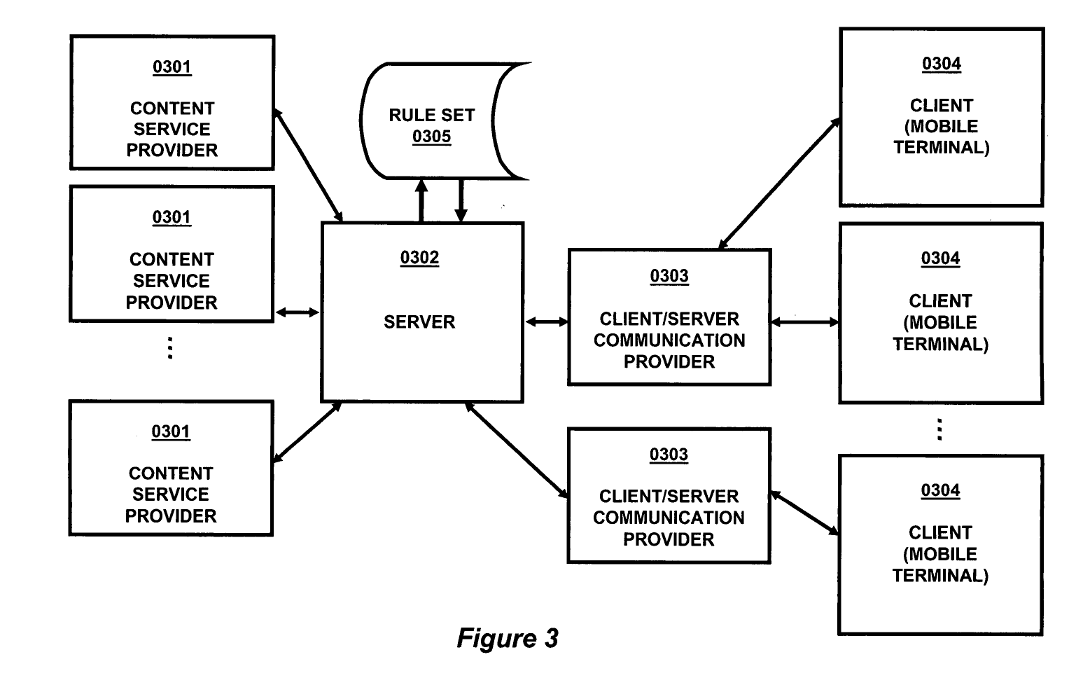

FIG. 3 illustrates how a server 0302 can provide content to a plurality of clients 0304 in accordance with one embodiment of the invention. The data connectivity between a server and a content service provider 0301 may be implemented in a variety of ways. For example, in terms of the example environment illustrated in FIG. 1, server 0302 can be implemented on a server 0108 and communicate with a client 0304 such as a mobile communication device 0102 via client/server communication providers 0303 such as the wireless network.

Server 0302 communicates with clients 0304 through one or more client/server communication providers 0303. Thus terms of the example environment described above with reference to FIG. 1, client/server communication providers 0303 may be a cellular carrier or other wireless service provider. Server 0302 may provide application service through just one, or a plurality of client/server communication providers 0303. Alternatively, providers 0303 may use other types of cabled or wireless communication services such as, for example, wide area networks, local area networks and other communication interfaces. Rule set 0305 is accessed by server 0302 to provide the content bearing applications to clients 0304, in conjunction with data from content service providers 0301. Rule set repository 0305 may be maintained at server 0302, or at a remote server that is in communication with server 0302.

Referring again to FIG. 3, in terms of the example illustrated in FIG. 1, a client 0304 may be a mobile communication device 0102 such as, for example, a smart cell phone, a personal digital assistant (PDA) with wireless access, a notebook computer with wireless access, or any other client device. In alternative embodiments data connectivity may be by cable, optical fiber, or other wired or wireless means.

In an embodiment of the invention, a client/server communication provider 0303 provides a bidirectional data link between a server 0302, and a client 0304. For example, in terms of the example environment illustrated in FIG. 1, client/server communication provider 0303 is a wireless communication provider that can provide communicative connectivity between the mobile communication device 0102 and one or more devices such as servers 0108 or content service providers 0111 associated with the network. In the event that client/server communication provider 0303 is wireless, it may conform to one of a variety of wireless cellular phone or wireless data communication standards such as code division multiple access (CDMA), frequency division multiple access (FDMA), time division multiple access (TDMA), or orthogonal frequency division multiple access (OFDM), or other types as are well known to one of ordinary skill in the art. The data communications may be part of a circuit switched call, or an “always on” type of packet data service.

In the embodiment of the invention shown in FIG. 3, client/server communication provider 0303 can be implemented so as to generally provide a substantially transparent channel of communication between client 0304 and server 0302. In this embodiment of the present invention, server 0302 links client 0304, via client/server communication provider 0303 to a content service provider 0301. Server 0302 can be any type of computer with associated memory storage and data connectivity. As discussed above, server 0303 can be configured to transform data flows, manage client UI Engines, and perform other administrative and management functions.

Having thus generally described a high-level overview of various features of the invention, the operation is now described in greater detail. FIG. 4 provides a more detailed description of one embodiment of server 0302 of FIG. 3. In this particular embodiment, client interface 0402 communicates with clients through air interface 0401. In other embodiments, other communication interfaces with clients may be used, alone or in combination. Client interface 0402 communicates with content provider 0111 via content adapters 0407 and a communication channel, which is network 0105 in the illustrated example. As shown, the application server 0302 in this embodiment comprises a client interface 0402, selection logic 0403, rule set translator 0406, meta rules 0405, and content adapters 0407.

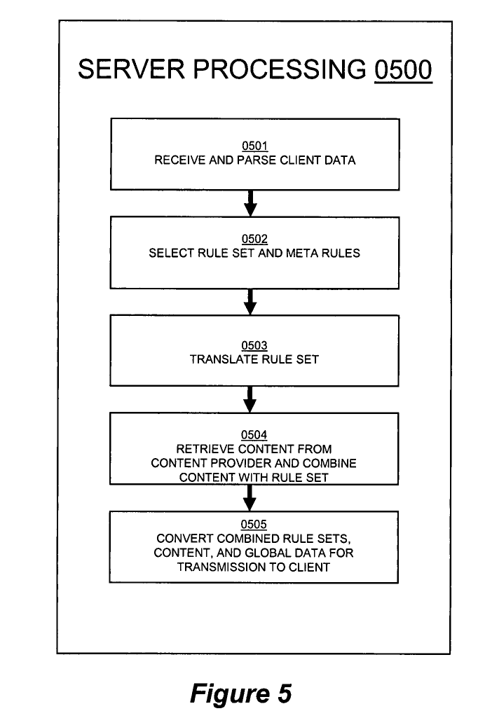

FIG. 5 is an operational flow diagram illustrating a process by which the example server system illustrated in FIG. 4 can process client requests for content in accordance with one embodiment of the invention. Some aspects of the operation of the server system of FIG. 4 can be better understood in relation to the operation of the server as shown in the flowchart of FIG. 5. Referring now to FIGS. 4 and 5, in step 0501, client interface 0402 receives a message from a client 0304 (not shown in FIG. 4) via air interface 0401. As described above, the message received from the client 0304 can be in the form of an event that indicates information about the content being requested such as, for example device characteristics. As one example, the event can provide information pertaining to a particular content screen being requested and information about the device requesting the content. Additionally, in one embodiment, the event can include information specifying the information or type of information that is to be retrieved to fill in the content data screen. Due to the fact that data transmission rates between a mobile communication device and a server system tend to be low in certain environments, UI components and events may be encoded in binary in order to increase the responsiveness of the applications.

In one embodiment, device characteristics are provided in a file that can be stored on the client device. This thin client, or other file, is, in one embodiment, designed to consume minimal storage space, while providing appropriate information regarding the device characteristics for assembly of the appropriate rule sets from a local cache or from an external source. In one embodiment, this file is maintained by the client and used for all applications. In another embodiment, the file is downloaded for a new application and reused for that application when an event is transmitted to the server. In a hybrid approach, device information is maintained in a file and augmented by application specific or other information that may be provided by an application or other event.

Table 1 includes exemplary device characteristic information such as display screen dimensions, and device characteristic software information such as Client-server protocol version ID number and UI Engine version ID number, in addition to data service request and status information. Table 1 represents a specific example of information that can be included with a service request message. Other examples will become readily apparent to one of ordinary skill in the art after reading this description, including modifications, deletions, additions, and substitution of one or more fields or field definitions.

TABLE 1
Service Request Message (from Client)

| Field | |
|---|---|
| No. | Description: |
| 1 | Client initiates call? (Y/N) |
| 2 | Screen size: x-dimension (no. of pixels) |
| 3 | Screen size: y-dimension (no. of pixels) |
| 4 | Client-server Protocol version ID no. |
| 5 | UI Engine (client) version ID no. |
| 6 | Application version ID no. |
| 7 | Application name (char. strng.) |
| 8 | Client Device ID no. |
| 9 | Client SW platform type (e.g., J2ME, BREW ®, SmartPhone . . . ) |
| 10 | Type of Exit from application (“time out” and/or menu option) |
| 11 | Pair Data? (Y/N) (should two items of data be associated?) |
| 12 | Is current display a splash display (y/n) |
| 13 | Current Display page name: name of current display page |
| 14 | Next Display page: name of the current display page dataset |
| 15 | User Entered Data - data values entered by the user (for |
| | initialization protocol, it will be the version ID for the display |
| | page. |

Client interface 0402 can respond to the client with a service request, of which an example is given in Table 2. Note that this service request message can include information about the requested application, as well as warning and error status information for potential use by the client.

TABLE 2
Service Request Acknowledgement (from Server)

| Field | |
|---|---|
| No. | Description: |
| 1 | Client initiates call? (y/n) |
| 2 | Exit application on error (y/n) |
| 3 | Client-server Protocol version ID no. |
| 4 | UI Engine (client) version ID no. |
| 5 | Application version ID no. |
| 6 | Application name (character string.) |
| 7 | Server-initiated error condition (y/n) |
| 8 | Server-initiated warning (y/n) |
| 9 | Client Device ID no. |
| 10 | Client SW platform type (e.g., J2ME, BREW ®, SmartPhone . . . ) |

Table 2 represents a specific example of a service request acknowledgement. Other examples will become readily apparent to one of ordinary skill in the art after reading this description, including modifications, deletions, additions, and substitution of one or more fields of field definitions.

referring still to FIGS. 4 and 5, in step 0502, selection logic 0403 examines the message and selects a rule set corresponding to the current state of the application being requested by the message. For example, this can be retrieved from a repository of rule sets 0404. Rule sets 0404 in one embodiment provide information that can be utilized to format or otherwise allow content to be conformed to characteristics of a particular device or device class. Thus, for example in one embodiment, selection logic 0403 utilizes information about the requesting device in making a determination as to which rule or rule set of a group of rules or rule sets to retrieve in fulfilling the request embodied by the message.

Information regarding the device or device characteristics can be provided to selection logic 0403 in a number of different ways. For example, in one embodiment, the message from the client device includes a listing or specification of the one or more device characteristics, including application state descriptors, for a particular mobile communication device. As such, selection logic 0403 can look to those characteristics to determine a rule set that matches those characteristics. As another example, the message can include an identification of the device or device type that is requesting the content. This identification can be used to access a look-up table or other repository that identifies the characteristics associated with the device identified by the device ID. Depending on the implementation, the message can contain this information each time a message is sent from the requesting device.

In one embodiment, a rule set may not be available to identically match each of the characteristics specified for the requesting device or device type. In that event, selection logic 0403 can be implemented so as to select a closest or best match depending on a number of criteria. Thus, for example, assume that a set of device characteristics includes a language preference, a screen aspect ratio, and a font size specification. If in this example, also assume that there are three possible device languages, three possible screen aspect ratios, and three possible font sizes, there are 27 potential different rule sets to match each of the 27 permutations of device characteristics. However, it may be impractical to provide this many rule sets for a given application. Indeed, considering the number of devices that exist in actuality, it is likely that there may not be a sufficient number of rule sets to match every possible permutation of device characteristics.

Therefore, continuing with the previous example, selection logic 0403 may be implemented to select the closest matching rule set based on available rule sets and an evaluation of their differences in the three parameters of font size, language, and aspect ratio. To aid in computation of dimensions and also to potentially resolve ambiguities, the device characteristics can be weighted such that selection can be made based on the relative importance of the various parameters. Consider, for example, a scenario where matching aspect ratios and font sizes are only available in rule sets that do not have a matching language, yet a rule set in the matching language is available with a less than ideal font size and/or aspect ratio. In this example, the best choice may be chosen as the rule set that addresses the appropriate language, as the screen may otherwise be unusable to the end user if it is not in a language that he or she can understand.

Selection logic 0403 can also be implemented to determine or select a set of meta rules 0405 on the fly or from meta rule repository (on the basis of client characteristic information included with the message) to be used to translate the selected rule set. Thus, in one embodiment, meta rules 0405 can be implemented as rules that are used to modify (for example, to change or constrain) rule sets 0404. Thus, in this embodiment, a rule set translator 0406 is used to apply one or more selected meta rules 0405 to the selected rule set to result in a translated rule set that can be used to conform the content to the requesting device.

One example of where a meta rule 0405 can be implemented is a situation where it is preferable or desired not to exceed a given maximum font size for a device even if the device itself is capable of supporting a larger font size. For example, assume that a particular communication device can support a given font size, yet the display characteristics are such that it is more desirable to use a smaller maximum font size that this device can handle. In this instance, the meta rule translator 0406 can identify the device, obtain the appropriate meta rule 0405, which modifies the rule set to specify the preferred font size. As such, this is one example where a meta rule 0405 can be implemented to modify a rule set that may have been chosen by the selection logic based on given device characteristics. Thus, in this example, the meta rule 0405 would serve to insure that the selected rule set 0404 utilizes the preferred maximum font size as opposed to a larger, but not preferred, maximum font size that may have been specified.

Other examples can include a situation where certain devices perform best when limited to a plain font only, as opposed to various stylized fonts that they may otherwise support, or a situation where a particular keyboard type is specified for the application. Thus, for example, as these examples illustrate, a meta rule 0405 can be used to modify a rule set by rule set translator 0406. In one embodiment, the modification can be done by adjusting one or more of the parameters that may be specified in a rule set 0404. Meta rules are discussed in greater detail, below.

Rule set translator 0406 delivers the translated rule set to client interface 0402. If meta rules are not applied, the non-translated rule set is returned by selection logic. In a step 0504, Content adapters 0407 retrieve and process dynamic and any updated static data from content providers 0111 via network 0105 for combining with the translated rule set by client interface 0402. More specifically, in one embodiment, the translated rule set defines areas or locations on a display page where information or other content is to be included with the final rule set for delivery to the client device. As such, in this step 0504, content adaptor 0407 communicates with the appropriate content provider 0111 (via network 0105 in the illustrated example) to retrieve the appropriate information or other content for inclusion with the display page as defined by the rule set.

As an example, consider the hypothetical application illustrated by FIG. 2. In this example, the information or content to be retrieved from a content provider 0111 and included with the meta rule can include information pertaining to the various gas stations, restaurants, hotels, or other items for which information can be supplied via the hypothetical application. In one embodiment, the information is embedded in the rule set indicating which content is to be retrieved from a content provider 0111. In alternative embodiments, identification of the appropriate content for inclusion with a rule set can be made by a number of different techniques including, for example, including an identification of the content with the event that is generated by the client to request the new rule set, including an identification of the content within the rule set itself, or otherwise appropriately identifying content for retrieval. The content can be identified directly or indirectly, for example, via a look-up table.

In one embodiment, an identification key is included with the event generated by the client application, preferably utilizing exit information associated with the application screen. This identification is provided to the content provider which utilizes the identification to identify the particular content to be retrieved, retrieves the content, and provides it to content adapter 0407 for inclusion with the rule set. Of course, as these examples serve to illustrate, there are other methods and techniques that can be utilized to identify updated content for inclusion with the rule set.

In a step 0505, the translated, rule set, combined with the appropriate content is transmitted back to the client. Although rule sets are principally sets of interrelated display pages, they may also contain global data. Global data can comprise, for example, bitmapped images, that are included once and reused by multiple display pages in order to save memory and communication bandwidth. Global data may be cached only for the duration of an application's execution, or it may be maintained indefinitely, or until updated. Global data may be used by a single application, or it may be used by multiple applications. Global data can include data that is global to the particular client itself or data that is global to a particular application.

For example, a given application may have a brand or other logo associated therewith that is included in one or more of the display screens of the application. For example, consider the exemplary embodiment illustrated in FIG. 2, where each screen includes the brand designation “TravelPal” on each screen. In another example, a brand or other identification of the mobile communication device may appear on the screen of one or more applications running on the client device. As yet another example, where the client device is a mobile communication device such as a cellular telephone, the cellular carrier's brand or logo may also appear on one or more screens of one or more applications running on the device. Global data is preferably cached locally to the client device to conserve bandwidth and other resources. However, global data may also be cached at other locations and communicated to the client device for inclusion with the display.

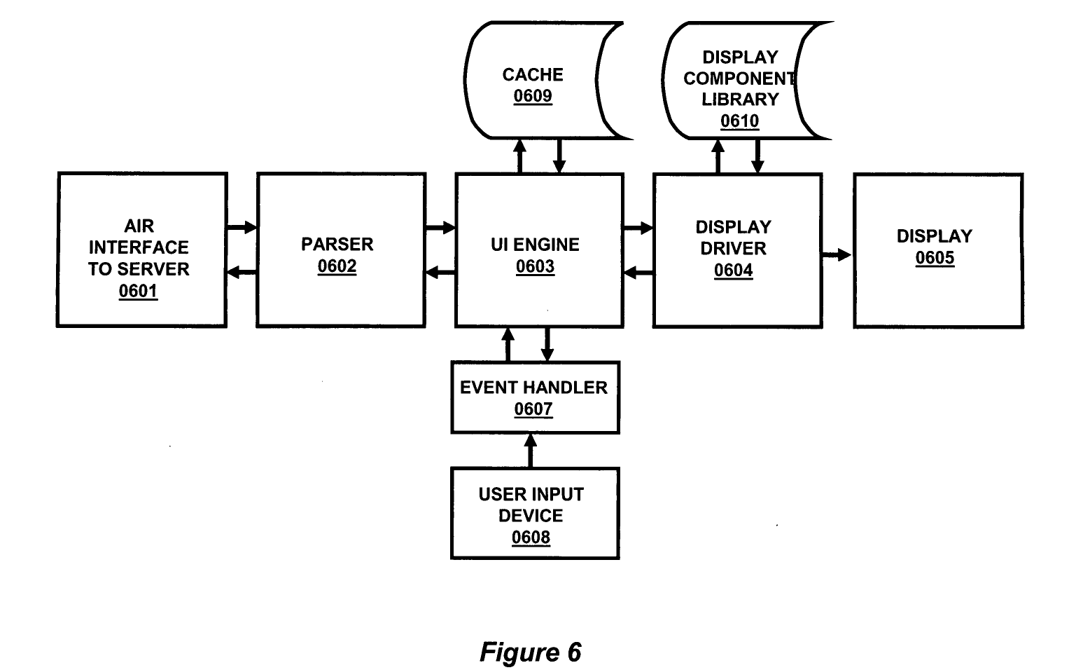

FIG. 6 is a block diagram illustrating an example implementation of a client device in accordance with one embodiment of the invention. The various components of the client may be implemented in hardware, software, firmware, or any appropriate combination of hardware, software, and/or firmware. In this particular embodiment, bidirectional communication with a server, such as described above in relation to FIG. 4, is achieved via an air interface 0601. For example, where the client device 0102 is a cellular telephone, air interface 0601 can be implemented utilizing the cellular communication channel between the cellular telephone 0102 and a base station 0101. Although not illustrated in FIG. 6, in this example, additional communication equipment may be included between the server 0108 and the air interface 0601.

To accommodate the conversion of data files to and from binary representation for transmission efficiency over the air interface, a parser 0602 can be included convert data files to binary for transmission, and also can convert received binary data files to http, or any appropriate data format, for subsequent processing by a UI engine 0603. In one embodiment, UI engine 0603 runs on top of the operating system of the client, and implements an improved user interface for an application on the client.

A display driver 0604 can be included and operably connects UI engine 0603 and client display 0605 for displaying application display pages. Although for the purposes of illustration in this embodiment, display 0605 is a visual display, audio, tactile and other output devices may also be used. Display Driver 0604 accesses display component library 0610 to generate actual display pages from received rule sets (optionally augmented with content and global data).

In one embodiment, a display page may be defined as a display component that is built with lower level display components. Table 4 provides an example of a set of display components that may be included in display component library 0610, and lists associated parameters that can be provided in one embodiment of the invention. These are discussed in more detail, below.

UI engine 0603 can receive user interface inputs from user input device 0608 via an event handler 0607. Such user inputs can include key depressions, touch screen or touchpad actuations, joystick actuations, mouse actuations, or voice activated actuations, to name a few options. UI Engine 0603 can also interface with a cache 0609 to retrieve cached display pages (rule sets), global data and other information. Cache 0609 can also store application state information, application version number information, and display page version number information, as well as UI version number, client ID, display and UI input device descriptions, and other types of information as discussed herein. Additionally cache 0609 can retain cookies or other files or information left by the execution of applications for later retrieval by applications.

During processing of a rule set, in one embodiment the rule set is parsed and saved for event processing. Event processing can occur, for example, when a UI Engine is informed by an event handler of a user interface actuation such as, for example, a graphical button on a GUI or a keystroke on a keypad. When the user instructs his or her mobile communication device to execute an application, an initial UI component is constructed from an application rule set and content data, either locally cached and/or received from the server system, resulting in a display page such as a splash screen or login screen, for example, to be presented on mobile communication device 0102.

In response to a user input, for example in response to actuation of a button drawn on the mobile communication device display screen as instructed by the UI engine, event information is transmitted from the UI engine to the client interface. This event information can include information such as, for example, the application name, screen name, current application status, operation asserted by the user (such as a button press for a given button name) and any user input data. Based on the this event information, client interface retrieves and provides the appropriate rule set, for example as described above with reference to FIGS. 4 and 5.

The air interface to the server 0601 can be implemented in one of many alternatives including those that are readily known to those of ordinary skill in the art. For example, the air interface component for a mobile communication device 0102 could be a wireless data modem implemented in conjunction with wireless voice services.

A Parser 0602 can also be included to converts various message and data formats that may be used by UI engine 0603 to, and from, a more efficient binary file format for transmission and reception over the air interface. For example XML encoded files may be used by UI engine 0603 in operation. However, XML encoded files encode long text based names such as

“<SCREE_ID>TIMESHEET_APP_SCREEN_{—}5</SCREEN ID>”

with 8 bit or 16 bit numbers for example representing a screen identification for example screen ID ‘0101’ (5). These files are typically larger than their binary counterparts. For instance, in this example the XML entry for screen identification including tags would require 46 bytes to be transmitted while a binary formatted message where one byte is reserved in a particular location in a buffer yields a factor of 46 in reduction of bits sent. This can provide an advantage when the amount of fields sent is large. As memory is cheap, the XML may be kept as is for debugging purposes or auditing purposes on the server and also encoded into binary blocks for ease of assembly at content insertion time.

In one embodiment of the invention, the message may have been originally expressed in http, or a data format such as XML, at the client, but converted to a binary file representation at the client, prior to transmission via the air interface, in order to conserve transmission bandwidth and improve transmission efficiency. In such cases, client interface 0402 may convert the binary file representation back to http, or another comparable data format, subsequent to further processing by the server. This conversion operation is referred to as parsing. Once the data received by client interface 0402 via air interface 0401 has been parsed, if parsing is used, the client interface 0402 forwards the message to selection logic 0403.

Returning still to FIG. 6, UI Engine 0603 executes instructions used to implement the user interface. UI Engine 0603 in one embodiment is software that executes on a microcontroller or microprocessor in the mobile communication device client. Such a microcontroller or microprocessor also may execute other tasks for the mobile communication device on a time and resource sharing basis. For example, air interface 0601, parser 0602, event handler 0607, and display driver 0604 may also execute, at least in part, on the same microcontroller or microprocessor that executes UI engine 0603.

UI engine 0603 communicates with the server through the air interface and the optional parser, as described above. UI engine 0603 interfaces with cache 0609 and event handler 0607. Cache can be implemented as memory storage circuitry and is used to store rule sets, global data, cookies, and application state information for a client-server application on the mobile communication device. Event handler 0607 captures and processes user input device actuations from the user input device 0608, prior to passing them on the UI engine 0603. Display driver 0604 receives higher-level display page descriptions from UI engine 0603 and processes them according to display components stored in display component library 0610.

As with cache 0609, display component library 0610 can be implemented using memory storage circuitry. In some embodiments, cache 0609 and display component library 0610 may be implanted using the same memory circuit(s). Display component library 0610 contains display components (described in detail below) that translate the higher-level display page description (described above) into the actual displays that are shown on hardware display 0605. Display component library 0610 can have a communication path with UI engine 0603, so that display components can be initially stored, and later updated.

Because data services may be initiated by a client, by another client via the server, by the server, or by the content provider via the server, both “pull” (i.e. initiated by the client) and “push” (i.e. initiated by or via the server or a third party) scenarios can be considered.

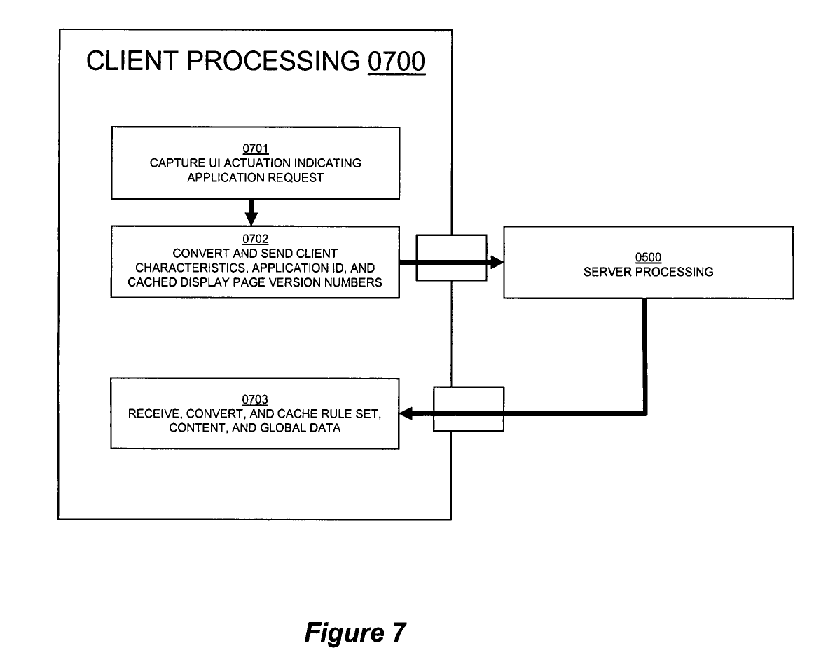

A pull type embodiment of an operation of the client of FIG. 6 can be better understood in connection with the flowchart shown in FIG. 7. FIG. 7 illustrates an example of client processing in accordance with one embodiment of the invention. Referring now to FIG. 7, in step 0701, event handler 0607 captures a user actuation of user input device 0608 and alerts 0702 UI engine 0603. For example, a user may select an icon on a screen of the mobile communication device that indicates the invocation of a specific application or service. Alternatively, a user may select one or more items from a displayed list of items in an application. Or the user actuation may be the depression of a single key, either hard labeled or soft labeled.

UI engine 0603 can process the notification according to logic embodied, for example, as an exit criterion in a display pages of a rule set to generate a data message requesting an application service. This message can also contain information about the client's status, such as, for example, client device characteristics, UI engine version number, application version number, version numbers of cached information, and current application state (if any). Then parser 0602 and air interface 0601 convert and transmit the message, respectively, to a server system such as the one described in connection with FIG. 4.

In step 0500 of FIG. 7, the server processes the transmitted message and returns a message to the client. In one embodiment, this processing can be performed as described above in connection with FIG. 5.

In step 0703 the client receives, converts, and caches returned rule set, content, and global data. The UI engine may also display a first display page of the application session on the screen of the mobile communication device. The above method may be used, for example, when a new client application is loaded for the first time, or when a previously loaded application requires updating.

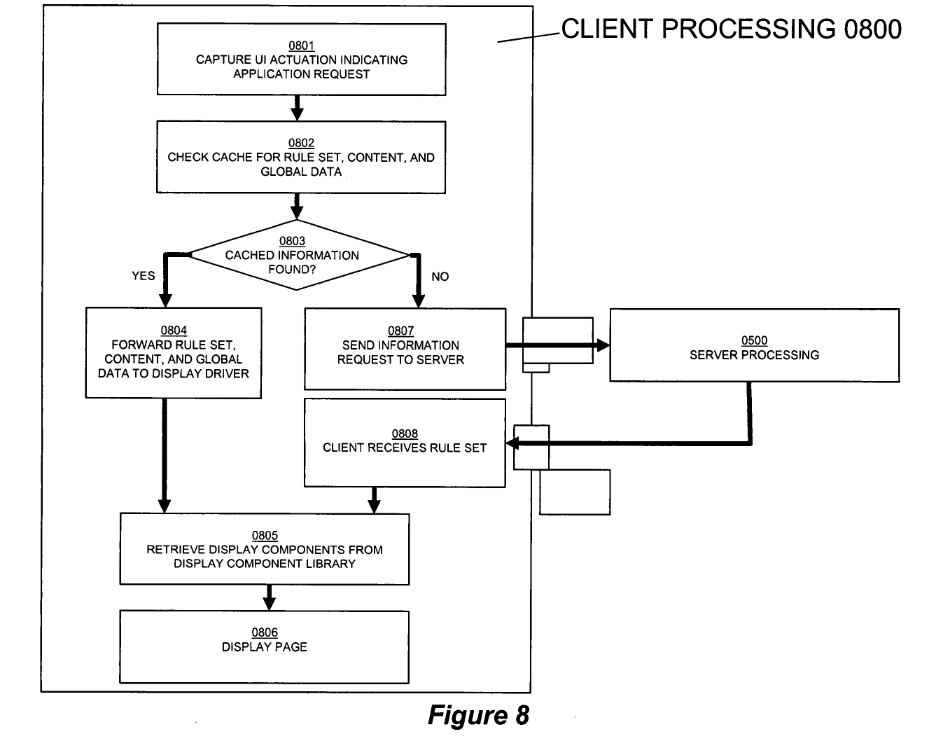

FIG. 8 is an operational flow diagram illustrating a process for displaying content in response to an event at a client device in accordance with one embodiment of the invention. In the embodiment illustrated in FIG. 8, an action occurring at the client device can result in a request to a server 0108 for content.

Referring now to FIG. 8, in a step 0801, an event occurs. For example, in the embodiment illustrated in FIG. 6, an event handler 0607 captures an application event indicating that additional content is requested. As described above, this can occur as a result of user interaction, interaction by another device, or via operation of the current application. For example, a user may make a menu selection, keypad entry, or other action or user input resulting in the identification of additional content to be retrieved. As another example, exit information for a display screen may result in automatic generation of an event, for example, at the expiration of a time out period. As an illustration of this latter example, a splash screen may be configured so as to display on the client device for a given period of time and, at the end of the period of time, automatically transition to a subsequent screen such as, for example, a Welcome screen. Thus, as these examples illustrate, the event can include information such as, for example, an indication of a current screen as well as an indication of subsequent content or a display screen as requested as a result of the execution of the application and, where applicable, interaction with a user or another device. Thus, in one embodiment, the event indicates a subsequent rule set or display screen or other content to be displayed.

In a step 0802, UI Engine 0603 checks cache 0609 to determine whether local copies of information specified by or identified by the event are stored locally. Thus, for example, UI Engine 0603 can check cache 0609 for locally-stored versions of the display screen, content, and global data. If some or all of the data are found in the local cache, as illustrated by step 0803, then the operation continues at step 0804. In step 0804, the locally stored information is utilized in generating or providing content for the subsequent operation of the application. Thus, for example, a locally stored display screen, content information, and any global data, can be retrieved from the cache, appropriately assembled (if not stored in a pre-assembled fashion), and provided for display. This is illustrated by steps 0804, 0805, and 0806.

If, on the other hand, in step 0803 certain of the requested information is not found in cache 0609 or if the cached copy is stale, in a step 0807, a request is sent to the server 0108 for processing. This is illustrated by steps 0807 and 0500. Server processing, as illustrated in step 0500, can occur in one embodiment as discussed above with reference to FIGS. 4 and 5. Thus, in a step 0808, the updated rule set is received by the client device. The rule set and any associated updated information can be used to update the cache 0609. Additionally, this information can be used to display the appropriate information for the subsequent operation of the application such as, for example, the subsequent display screens, as illustrated by steps 0805 and 0806. Although the above exemplary process discussed the display of content in terms of displaying either cached or newly-retrieved content, the system can also be implemented so as to combine one or more cached and newly retrieved content items in a single display page.

Having thus described an example process for retrieving content information for an application, this process is now described with reference to the hypothetical application illustrated in FIG. 2. Referring now to FIGS. 2 and 8, in a step 801, the event handler captures an actuation indicating a content request. Thus, when the user selected “Restaurants” in FIG. 2b, the event can include information such as, for example, the executing application (in this example, TravelPal) and the exit information associated with the selection “Restaurants.” Thus, in this embodiment, the event information indicates (directly or indirectly) that the operating application is to return the screen illustrated in FIG. 2c with a list of restaurant types available for selection. The event is provided by event handler 0607 to UI Engine 0603 to effectuate retrieval of the screen of FIG. 2c with the appropriate information. As described above with reference to steps 0802, 0803, 0804, 0805, 0807, 0500, and 0808, UI Engine 0603 uses the event to obtain the next screen (in this example, FIG. 2c) from server 0108 or from the cache 0609. In this operation, parser 0602 can be used to generate appropriate binary information from the event object such that the appropriate request can be forwarded to the server 0108 for processing, as illustrated by step 0807. A network adapter or other communication interface, although not illustrated in FIG. 6, can also be provided. Parser 0602 can also be utilized to convert the received binary information into an appropriate object for display by the display unit 0605.

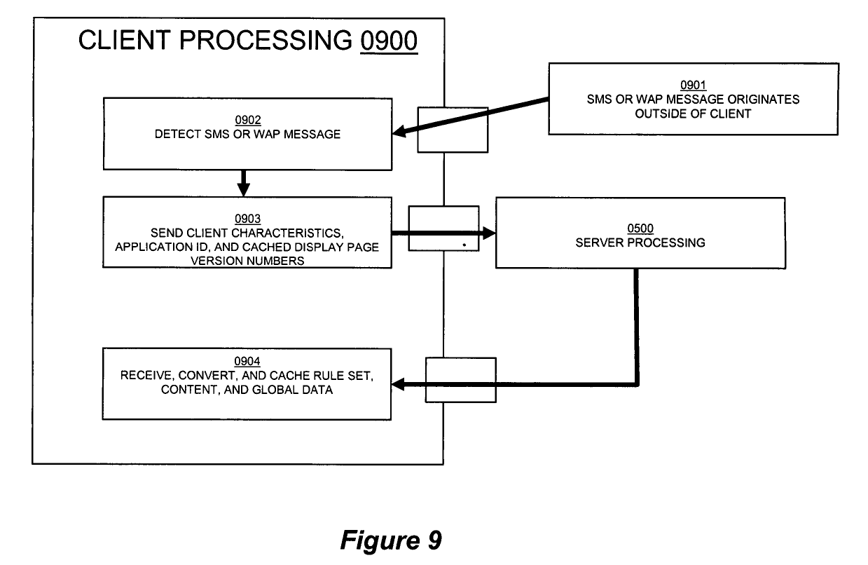

FIG. 9 illustrates a “push” type embodiment in which the client does not initiate the interaction with the server. In step 0901 the server, or a third party (for example, another client or other device) sends a “push” type message to the client, for example via SMS (short message service) or WAP (Wireless Application Protocol). The UI engine detects the message in step 0902, and generates a message for transmission to the server in step 0903. The process that follows can be the same as described in connection with FIG. 7 in one embodiment. This method can be useful in cases where someone other than the client user needs to communicate with the client user via a client application. An example of such an application is wireless e-community services.

In the above example embodiments, a translated rule set exchange can ensue between server and client. In such a converted workflow exchange, a content provider typically sends formatted content to a client, wherein the format of the content is converted by the rule set translator 0406 such that it is more optimally presented by the UI engine 0603 on the client. Also, rule set translator 0406 may transform user interface actuation data or mobile communication device telemetry data being sent from the client to the content provider. An example of such a transformation is the mapping of client keypad assignments to a map of standard keypad assignments. Additionally, instructions to configure the UI Engine on the mobile communication device can be added to the workflow and sent to the mobile communication device.

The client interface 0402 converts and processes the data message, builds the display page component from the rule set and content data, and provides the next display page to mobile communication device 0102a. This process can continue in this iterative manner as the content is executed on the mobile communication device 0102a.

Of course, there are embodiments where only one display page is downloaded, and subsequent UI components are not used to execute the content. The display pages and related global data can be installed and stored permanently on the mobile communication device 0102a. Alternatively, they may be dynamically loaded each time they are accessed. Display pages may also be cached for a session or otherwise as may be desirable for a given content item. Permanent storage techniques can include, for example, read-only memory, flash memory, or any other memory, and preferably memory that retains information during power down. [DON: This paragraph and the latter half of the previous paragraph are more appropriately described along with the FIG. 4 section.]

UI engine 0603, along with display component library 0610 and cache 0609 for implementing applications may be initially installed on the client by the manufacturer in nonvolatile memory, as is other firmware for a phone, they may be loaded at a service center or in the field through a data connection (for example, USB cable, IR, or Bluetooth®, etc.) with a personal computer, downloaded off-the-air as part of a wireless service provider's over the air service provisioning (OTASP) process, or even download via a wireless web browser that may already be on the smart phone. Client applications may be installed or updated (or have software bugs fixed) through the download of rule sets, global information, and display components.

When a user downloads an application into a mobile communication device, an embodiment of the invention allows for a UI Engine 0603 for the specific type of mobile communication device to be transparently downloaded before the first UI component of the application (for example a splash screen) is downloaded. In other embodiments, the UI Engine 0603 is downloaded at the factory, for example, by beaming from a cell phone or by infrared transfer to the mobile communication device. Any other method of downloading an application to a mobile communications device is in keeping with the spirit of the invention. Download of the UI Engine 0603 may also be part of the download of an application and a user may not be aware that a UI Engine has been downloaded. Regardless of the method in which the UI Engine for the device specific operating system is loaded, once the UI Engine is executing on a mobile communication device there are two tasks the UI Engine generally performs in one embodiment.

One task of the UI Engine is to display a UI component as requested by the application. This may involve a request to a server system (for example, server system 108) for combining a rule set for a given mobile communication device, application and screen with content obtained from a third party content provider. Alternatively, displaying a UI component may involve processing a message from another device locally such as, for example, a mobile communications device, and determining the subsequent UI component to display via logic local to the mobile communications device. Content adaptor 0107 can be provided to allow conversion of the native format of the content on the content provider's system 0111 to a format suitable for combination with a rule set in order to form a UI component for transmittal to a mobile communication device. The rule set specifies what events and data are sent back and when the events and data are sent to the rule interface component when a particular interface element for example a button is asserted by a user.

Another task is to act as an event handler for user inputs, which are interpreted and formed into events comprising an application name, screen name, operation name such as a button name and any user input data and either processed locally or sent to a rule interface component in a server system. Once the local logic or rule interface component has interpreted the event a second UI component for display on the mobile communication device is generated, possibly including content from a content provider. Alternatively, if a screen is not required to change, for example when a user has failed to enter an item required before accessing another screen, then the UI Engine may check the UI component comprising a rule set and locally highlight the field that is required before allowing an event to be sent to the rule interface component.

When a bug is found in an application the workflow module may be re-run in order to fix the application and re-deploy the rule set into the server system. In one embodiment, the UI Engines have the option of dynamically asking for a UI component every time, or caching the UI component for a session or permanently storing a UI component so that the application may only ask for content to fill the needs of a UI component. Each UI component may comprise a version ID which is simply checked at any convenient time in the UI Engine and if the UI component is found to be outdated regardless of the dynamic, cached or permanent status of the UI component on the mobile communication device, then the new version of the UI component may be downloaded to correct the fixed bug. Since this download happens automatically and since the deployed rule set was changed once, the result is that a bug can be fixed once and propagated to as many types of mobile communication devices as use the application seamlessly.

The version identification of the UI Engine may be checked at any time and the UI Engine itself may be reloaded into the mobile communication device. This may occur automatically or optionally by prompting a user. Since an update to a UI Engine affects only one mobile communication device hosting a device specific operating system only those mobile communication devices hosting the specific UI Engine are affected. This is unlike the automatic update of an application across all types of mobile communication devices at once since applications are independent of the mobile communication device.

As discussed above, a UI engine can be originally installed during a mobile communication device's manufacture using a data link of a cabled or wireless type. Alternatively, the UI engine can be downloaded using a browser program on the mobile communication device, for example, a WAP (Wireless Applications Protocol) Browser. The UI engine can be updated by a server whenever an application is initiated. The UI engine can also be updated via a data cable to a personal computer with access to an internet web site containing appropriated downloads. Another means for updating a UI engine is a wireless service provider's over the air service and provisioning (OTASP) capabilities. UI engines can also be updated from other mobile communication devices with cabled (e.g. RS232 or USB) or wireless (e.g. IR or Bluetooth®) connection.

When a user downloads an application into a mobile communication device, an embodiment of the invention allows for a UI Engine for the specific type of mobile communication device to be transparently downloaded before the first UI component of the application (for example, a splash screen) is downloaded. In other embodiments, the UI Engine is downloaded at the factory through an appropriate data link as readily ascertainable to one of ordinary skill in the art. Regardless of the method in which the UI Engine for the device specific operating system is loaded, once the UI Engine is executing on a mobile communication device, there are two tasks that the UI Engine may generally perform.

Alternatively, in order to optimize the precise application appearance, it is possible to also generate rule sets based on a resolution size for a device. This allows fine tuning of button sizes and label sizes, for example, in order to take full advantage of the layout of the mobile communication device's specific display and may default to a standard rule set if no optimization has occurred for a range of display sizes for a given mobile communication device type.

Rule sets can be considered as user displays or display screens containing content and content formatting rules that are linked to one another via generic events. These rule sets can exist independent of a mobile communication device operating system on which they may be implemented. The look and feel of each application can be independent of the mobile communication device in which each application ultimately executes. Each mobile communication device executes a UI Engine that is specific to that device and the real time operating running on that device. Device specific information may be available locally through the UI Engine and/or may alternatively be a part of the UI component sent to the UI Engine.

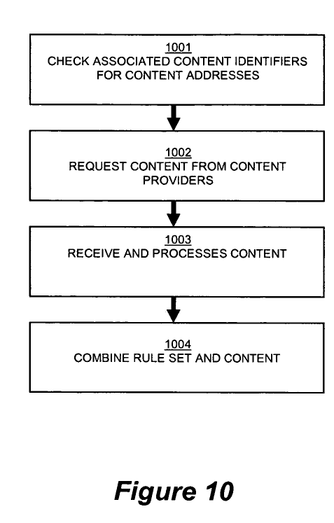

As described above, in one embodiment, one or more content adapters 0407 can be used to retrieve one or more designated content items from a content provider 0111 for inclusion in a translated rule set to be downloaded to a client. FIG. 10 is an operational flow diagram illustrating a process for retrieving this content in accordance with one embodiment of the invention. Referring now to FIG. 10, content identification information (e.g. content provider and access information) for a display page may be included in a rule set (i.e. imbedded content ID) and/or maintained in a database associated with a content adapter (i.e. associated content ID). An advantage of maintaining associated content ID is that it separates any associated maintenance or updating tasks for content provision with a content provider itself, rather than with a specific application. Thus if a content provider changes, it is only necessary to modify the content adapter. It is unnecessary to modify the rule set. This allows the present invention to separate development and maintenance tasks relating to application, content provider, and client device type.

In step 1001, a content adapter checks for the availability of an associated content ID. In one embodiment, the associated content ID is stored within the content adapter. Such ID can be stored as data structures that associate specific content providers, and specific content identification information within those specific content providers with a more general content description within the rule set. The associated content ID may include one or more content providers from which content can be extracted and combined. In another embodiment, associated content ID may specify a ranked ordering of more or less preferred content providers for obtaining specific types of content. If associated content ID is not found, the content adapter must rely on default associated content ID or specific imbedded content ID.

In step 1002, the content adapter requests content from appropriate content provider(s) using the respective associated and/or imbedded content IDs for a rule set. Such requests typically involve the sending of query messages to the URLs of content providers, along with associated requester ID information. The content providers may be accessed via an internet service provider, or through other computer network means such are well known to those of ordinary skill in the computer arts. The responses to the queries are generally received via the same network means that are used to send the queries.

In step 1003, the content adapter receives and processes the requested content. The content may be requested from one or a plurality of content providers. The content adapter processes the content on the basis of logic associated with the rule set. Processing can include filtering, combining, re-ordering, etc. in addition to the format specification of the rule set. Step 1003 can also include the collection and management of information such as, for example, billing information for cases in which content is provided for a per-item charge.

In step 1004 the client interface assembles the rule set and processed content to make a rule set with content that is subsequently transmitted to a client. The client interface can optionally recognize that some requested data is missing, or otherwise unavailable for assembly into display pages. In such a case, the client interface may either generate a warning or error message for transmission to the client, or it may forward a message back to the content adapter to retry retrieval of the missing content. In this step, the client interface may also convert from http or html to a more efficient binary data format for transmission to the client. As discussed above, a UI engine on the client uses the received rule set with content, along with cached display pages, global data, and display components to create display pages that are shown on the display screen of the mobile communication device.

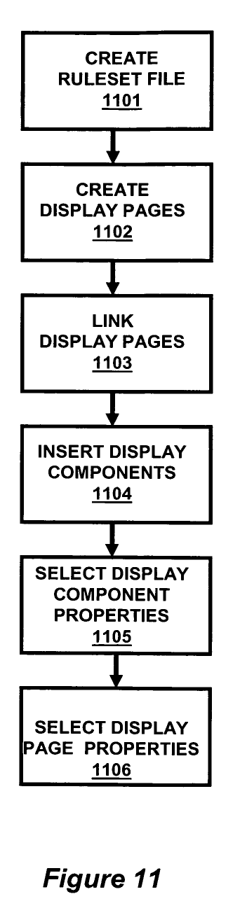

A procedure for creating a rule set in an embodiment of the invention is shown in FIG. 11. In step 1101 a rule set file corresponding to a particular application is created an named. The rule set may comprise multiple files, optionally organized in a directory with a hierarchical structure to facilitate the authoring and modification of large applications. The rule set file can be thought of as the universe of an application, into which all other design and specification information for generating display pages for a specific application is contained, independent of a particular client device type.

In a step 1102, one or more icons are inserted representing display pages to be shown on a mobile communication device's screen during the execution of the application. The display pages can be represented iconographically with various levels of detail in various embodiments of the invention. For example, the display pages may simply be boxes containing a text or other type of designator. Alternatively, the display pages may be detailed depictions of an actual display page at varying resolutions. The content editing of the icons is described below in relation to steps 1104 through 1106. In one embodiment of the invention, the icons may be manually positioned on a display screen of a computer development tool by a user. In an alternate embodiment, the icons can be automatically positioned on a display screen according to a preset schema. Icons may be individually inserted and placed, and then edited as described below, prior to the insertion of additional icons. Alternatively, many icons may be inserted and placed followed by editing as described below.

In a step 1103, the icons, representing pages, are linked to one another with lines or arrows to show how one may traverse from one display page to another display page during the execution of the application. To exit from a display page in an application, one may terminate the application, or invoke the display of a subsequent display page. In some cases, there may be no option regarding the next page to be displayed. In other cases, the next page to be displayed is conditional based on a user interface actuation and/or a server response. In other embodiments, the progression from one display page to another may be determined by time intervals. The properties to transition from one display page to another in an application can be set as described in connection with step 1106, below. A display page, other than an initial display page, is not an active part of an application unless it is linked to another display page as an exit criterion.

In step 1104, display pages are individually designed by inserting display components such as those listed in Table 4. Such display components may include, for example, text messages text boxes, bitmapped graphic images, icons, borders, etc . . . Many display components also have an associated selection of properties, for example, as listed in table. These associated properties are selected in step 1105.

In step 1106, properties for each complete display page are selected. Such properties may include, for example, whether or not a page should be cached by a UI engine, exit criteria for a page, and others as described above. Exit criteria refer to which page to display next and upon what action to display which page next if the application step is conditional. In one embodiment, exit criteria as set by filling in table entries associating events with corresponding next display pages.

As apparent to one of ordinary skill in the art, the display page linking step 1103 may occur before, during, or after steps 1104 through 1106. For example, once pages are created 1102 they can be linked 1103 or modified 1104-1106 at any time. Additionally, pages may be deleted or new pages created, linked, and modified at any time.

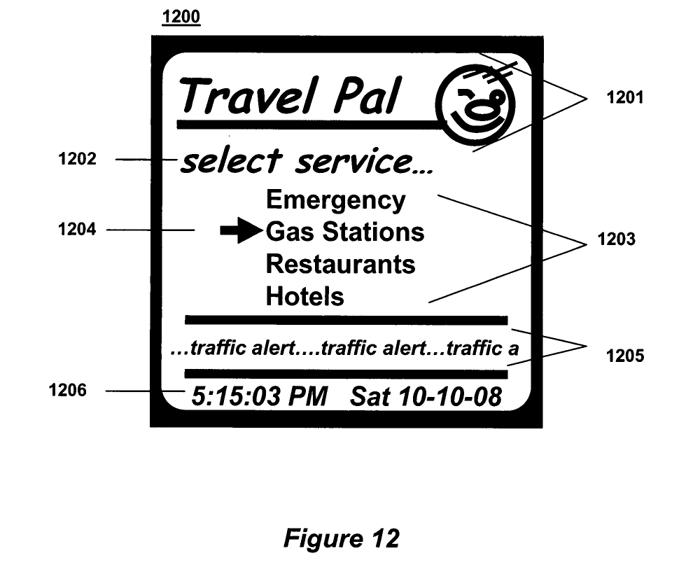

FIG. 12 illustrates an exemplary display page 0200 for a display screen of a mobile communication device in an embodiment of the invention. Different types of display components, such as described in Table 4, are shown. For example, 1201 can be a bitmapped image, or an animated display made of repetitively shown bitmapped images (for example, to repetitively depict the character's winking). The “Travel Pal” text may also be a bitmap to accommodate a special logo font. The horizontal line under “Travel Pal,” can be a bit map graphic in one embodiment. In another embodiment it can be represented as a vector drawn graphic element.

Item 1012 can be a formatted alphanumeric text box representing static data. Although the data is static, the data display need not be. For example, in some embodiments there may be repetitively flashing visual highlighting. In other embodiments, the static data may scroll horizontally or vertically.

Item 1203 can be a list of selectable items (corresponding to a selectable output criterion for a display page) with a cursor 1204 to indicate a user selection. The list may fit onto one display page, as shown, or it may be represented a box containing border icons to scroll horizontally and/or vertically. The selection icon is an arrow in the illustrated embodiment. Alternatively, other icons may be used such as bullet marks, check boxes, etc. For some embodiments, multiple list items may be selected. For other embodiments, the choice of list items may be exclusive.

Items 1205 and 1206 can represent dynamic content. For example item 1206 can be a formatted, continuously scrolling text box to display highway traffic data. A single traffic report may be locally cached and repetitively scrolled, until it is replaced by an updated report. In some embodiments certain transmitted data may contain triggers to stop scrolling, or to specially highlight a scrolling text box, for example, to indicate alert conditions.

Item 1206 can be a formatted text box that is periodically updated, for example, to display the current time and/or temperature.

Alternative embodiments of display components to implement alternative display pages for alternative applications are readily apparent to one of ordinary skill in the art. Although the example embodiments described above have been composed of some visual display components as described below in Table 4, it is easily seen how other visual display components can also be used. Additionally Table 4 can be expanded to contain additional display components. This unlimited flexibility can easily support unlimited creativity for application developers.

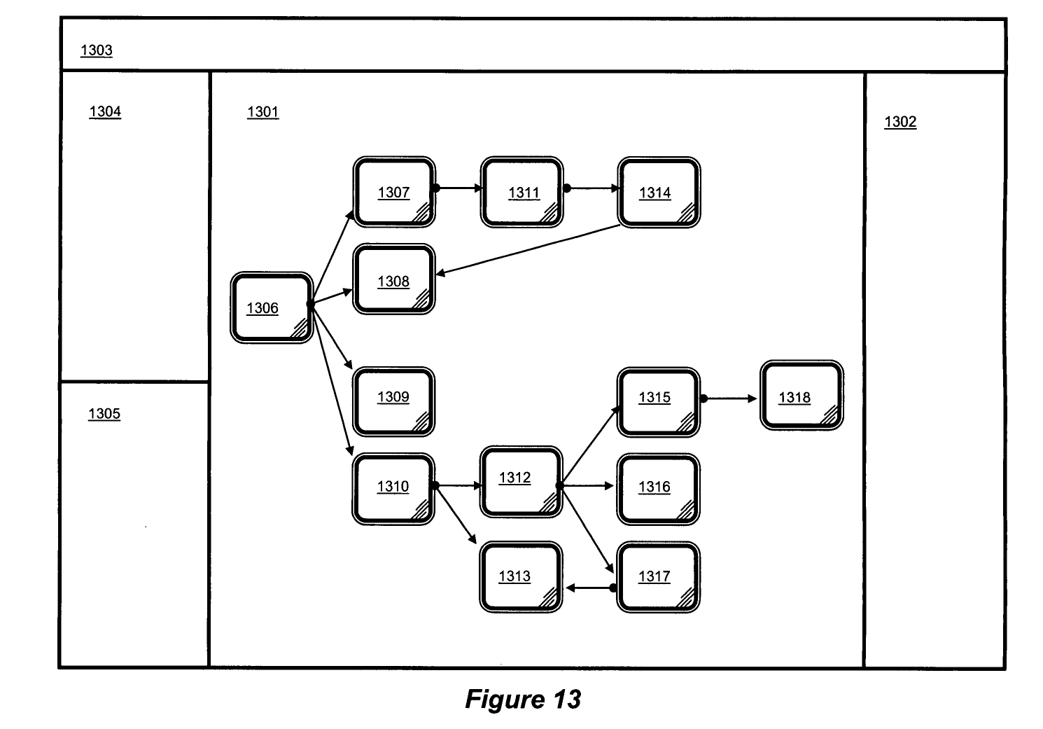

FIG. 13 shows a computer screen display of an embodiment of a software tool to create a rule set. The software tool can operate on a personal computer or on a workstation in a windows environment. The display is divided into five display panes 1301 through 1305. Display pane 1301 is pictured showing unique icons representing unique display pages 1306 through 1318 and arrows interrelating the display pages representing both conditional and non-conditional exit criteria, as discussed above. Display page icons can be added via a main operation button in display pane 1303, and repositioned using a mouse. In one embodiment, the following icons representing icons can be shown in display pane 1303: new document, open file, save file, image settings, page settings, default setting, screen width & height, deploy to server, download file from net address, and add screen. Interrelating arrows may be drawn from icon to icon by designating the icons using a mouse or, in another embodiment, they may be automatically generated by entering an exit criterion for a display page in a display page properties table.

Display pane 1302 list property settings for a display page corresponding to a display page icon in display pane 1301 that has been selected, for example, by a mouse click. Examples of display page property settings can include, for example: display page name, display page version, cache type, back button enablement, OK button enablement, home display page ID, time out, animation enablement, exit from application enablement, and user-defined menu items for user-defined exit criteria.

Display pane 1304 lists folders for root files and children of the root files in which the rule set is stored. As described above, a rule set may be stored as a single file, or for ease of development and maintenance, as a set of files in an associated hierarchical directory.

Display pane 1305 shows image set information, and rule set associations for image sets.

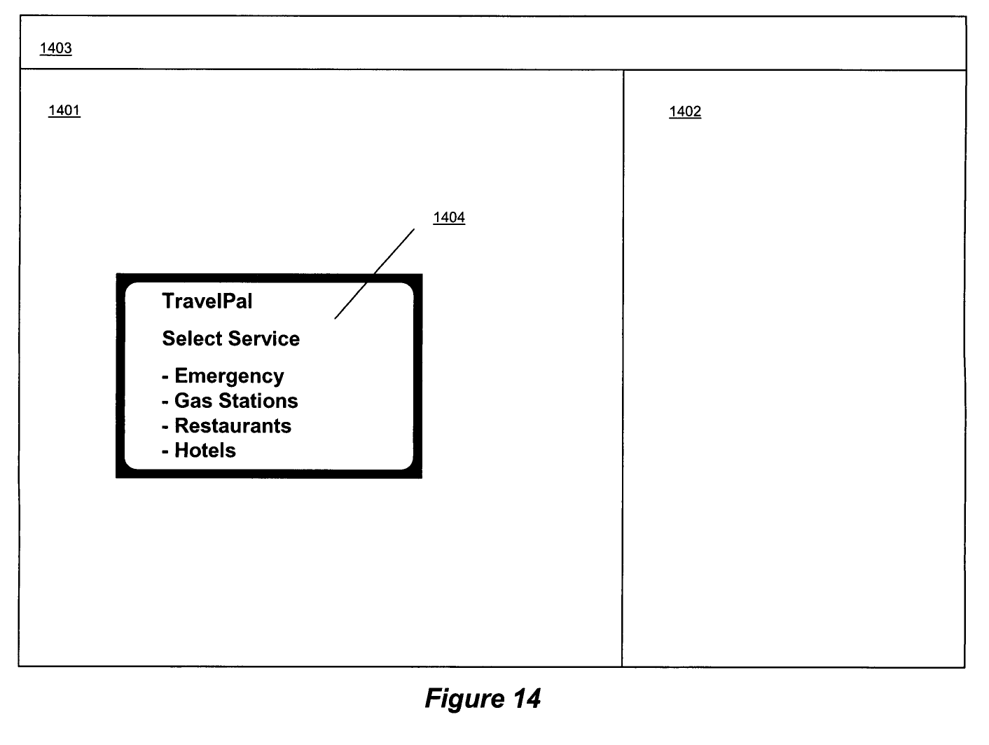

FIG. 14 shows another computer screen display of an embodiment of a software tool to create a rule set. Display pane 1401 presents an image of an actual display page 1404 with its display components for editing. Display pane 1402 lists property settings for a selected display component of display page 1404. Examples of such display component properties include: component name, component type, LocX, LocY, width, height, text style, value type, language, border size, fill border, rolling support, panning, relative dynamic, focusable, font style, alignment, foreground color, background color, foreground focus color, background focus color border color, and others. In some embodiments, individual display component properties have associated drop-down lists for selecting one among a finite number of options. In other embodiments, individual display component properties are entered as text into associated text boxes.

In one embodiment, display pane 1403 includes mouse-selectable button icons for commands relating to the page display such as: save, add/remove, add label, add text box, add text area, add message area, add choice box, add choice group, add list, add image, add button image, add hotspot, add shapes, and others.

Although the embodiment of a rule set comprising icons and relationships represented graphically has been described above, there is no requirement to show these elements in this manner and because in one embodiment a rule set can be an XML file or any other data format capable of defining rules, the rule set may be created in a text editor in this embodiment. The rule set (e.g. in a format such as HTML, XML, WML, etc . . . ) can contain screen names background colors, button names, dimensions and labels and any image data or content data that is needed or useful for an application including the events that allow for traversing screens in the application (for example, exit information).

Table 3 presents an exemplary listing of an XML (extensible markup language) workflow in an embodiment of the invention. Line 1 of the listing describes the encoding of the XML. Line 2 of the listing describes the name of the workflow as “demo.” Line 3 comprises an XML tag that surrounds a list of display pages or UI components. Line 4 is blank for ease of illustration. Line 5 comprises an XML tag that surrounds a block of XML that defines the “LOGIN” screen as described on line 6, along with a version identification of the “LOGIN” screen. The version identification is used in order to update the “LOGIN” screen on any mobile communication device that does not have the latest version. Other attributes are listed that determine the look and feel and functional settings for the UI component.

In addition, a MenuComponent block is described on line 11 that generates a value of “OK” if the menu item is selected as shown on line 13. Line 18 shows that when “MENU.OK” is selected, the next UI component to be displayed is the “WELCOME” UI component. Line 25 is a condensed version of the “WELCOME” UI component the details of which are not listed for ease of Illustration. Line 29 comprises an XML tag that surrounds a block of XML that defines the “SPLASH” screen as described on line 30. The “SPLASH” UI component comprises two exit points defined on lines 34 and 38 that direct the flow of UI components to the “LOGIN” or “WELCOME” screens depending upon the value of the “CLOGIN” argument meaning that when the “SPLASH” UI component times out, if the “CLOGIN” value has been set then the next UI component that is shown is the “WELCOME” screen, and if the “CLOGIN” value has not been set, then the next UI component shown in the “LOGIN” screen. The “CLOGIN” value may be passed to the UI Engine from the server system as true after the user has logged in. The “CLOGIN” value may be kept in a session of the server and passed as a cookie back to the UI Engine, for example.

```
TABLE 3
<?xml version=“1.0” encoding=“utf-8”?>
<WorkFlowData BackColor=“32896” Version=”2” Name=”demo”
  FlagColor=”8388736”> <WorkFlowDisplay pageDataList>
    <WorkFlowDisplay pageData LocX=”124” ID=”2” LocY=”222”
      Name=”LOGIN” Version=”632297280888915648”
      CachingType=”1” IsBackButtonEnbaled=”True”
      BorderSize=”0” FillBorder=”True”
    TimeOut=”3”” ImageData=”” ImageId=””
    ForeGroundcolor=”0”
    BackGroundColor=”16777215” BorderColor=”16777215”>
    <MenuComponent ListType=”” Name=”MENU”
    ComponentType=”10” ...>
      <WorkFlowValueList>
        <WorkFlowStringData Value=”OK” />
      <WorkFlowValueList>
    </MenuComponent>
    . . .
      <WorkFlowExitDataList>
        <WorkFlowExitData SelectedItem=”MENU.OK”
          Display page=”WELCOME” Display pageID=”1”
          ArgName=”” ArgValue=”” Type=”False”>
          <WorkFlowImageData ImageDataId=””
          BinaryData=”” />
        </WorkFlowExitData>
      </WorkFlowExitDataList>
    </WorkFlowDisplay pageData>
    <WorkFlowDisplay pageData LocX=”324” ID=”1”
      LocY=”65+ Name=”WELCOME”
      . . .
    </WorkFlowDisplay pageData>
    <WorkFlowDisplay pageData LocX=”50” ID=”0” LocY=”50”
      Name=”SPLASH” Version=”632297280708756592”
      CachingType=”1” IsBackButtonEnbaled=”False” ...>
      . . .
      <WorkFlowExitDataList>
        <WorkFlowExitData SelectedItem=”TIMEOUT” Display
          page=”LOGIN” Display pageID=”2”
          ArgName=”CLOGIN” ArgValue=”False”
          Type=”False”> <WorkFlowImageData ImageDataId=
          Binary Data=”” />
        </WorkFlowExitData>
        <WorkFlowExitData SelectedItem=”TIMEOUT” Display
          page=”WELCOME” Display pageID=”1”
          ArgName=”CLOGIN” ArgValue=”True”
          Type=”False”> <WorkFlowImage Data
          ImageDataId=”” BinaryData=”” />
        </WorkFlowExitData>
      </WorkFlowExitDataList>
    </WorkFlowDisplay pageData>
  </WorkFlowDisplay pageDataList>
  <FlagsDataList>
    <WorkFlowCookieData Name=”LOGIN” Type=”0” />
  </FlatsDataList>
</WorkFlowData>
```

Rule sets are typically developed for specific applications, although, depending on the applications, there may be cross-application sharing. Meta rules, such as meta rules 0405 described above with reference to FIG. 4, can be used to translate a rule set for an application to a rule set that provides an improved user interface for specific types of client devices running that application. Meta rules can be selected based on carrier technology and ID, mobile communication device screen size, and mobile communication device ID, among other criteria. If no meta rules exist for a specific criterion, then default meta rules can be used or no meta rule is used.

For example, some meta rules may be wireless carrier (service) provider specific, such as adding a carrier's logo or other features in display screens that help brand the carrier. Of course, this example can be implemented using global content as described above. Other meta rules may depend on client device screen size in number of pixels by number of pixels. Such other meta rules may change font sizes or icon bit maps or number of displayed content items per display page on the basis of the client device screen size. Still other meta rules may depend on client features such as cache memory size, in which case a rule set could be adjusted to change caching and application response speed characteristics. In such embodiments, the same meta rules can be applied to multiple rule sets representing multiple respective applications. Once a rule set has been translated by all appropriate meta rules, it can be subsequently processed for transmission to a client. Additional examples of meta rules are given below:
1. Select meta rules for a specific carrier, and if those meta rules are not found use the meta rules for a default carrier.
2. Select meta rules for a given client software operating system technology. If those meta rules are not found, use the meta rules for a default technology.
3. Select meta rules for a given client device type. If those meta rules are not found, use the meta rules for a default device type.
4. Select the meta rules for a given client screen size. If those meta rules are not found, use the ratios of the client's horizontal and vertical dimensions in pixels, to the respective horizontal and vertical dimensions in pixels of the reference screen assumed for the existing rule to scale selected display components in the in the existing rule. For example, a Best fit Ratio can be calculated as
   Best Fit ratio (“BFR”)=2−x_{c}/xᵣ+y_{c}/yᵣ
   where x_{c} and y_{c} are the horizontal and vertical dimensions in pixels, respectively, of a client's screen, and xᵣ and yᵣ are the horizontal and vertical dimensions in pixels, respectively, of the reference screen from the rule set. Use the BFR that is closest to zero as the best scaling factor for this screen size.
5. If the device screen is not same as the workflow screen size use the following meta rule:
   a. Zoom based upon screen ratio for components that has relative flag=false and type is not equal to Image or Image Button
   b. For Image or Image button use a best fit image set. Best fit image set is calculated using the Best Fit Ratio (BFR) as above
6. For the following devices modify the workflow rules
   a. If it is Motorola device (Motorola v260, Motorola V262, Motorola V265) use plain font only
   b. For all other Motorola phone change small fonts to medium fonts
   c. For treo600 change keymapper type to ASCII

The above meta rules are exemplary and, after reading this description, modifications, additions, substitutions, and deletions are readily accomplished by one of ordinary skill in the art.

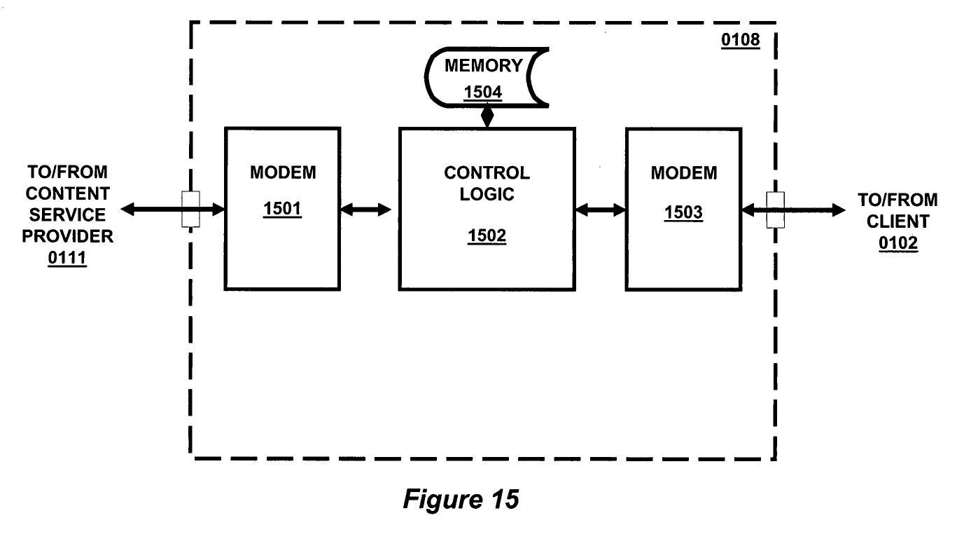

FIG. 15 describes an exemplary server hardware implementation 0108 of an embodiment of the invention. Server software and data is stored in memory 1504 that is accessed by control logic 1502 to perform methods of the embodiments. Memory 1504 also stores rule sets and meta rules. Memory 1504 may be one or more of any conventional computer memory types as are well known to those of ordinary skill in the art. Control logic 1502 can be implemented using a variety of commercial or custom server processors as are also well known to those of ordinary skill in the art. Modems 1501 and 1503 enable communication with a client 0102 and a content provider 0111, respectively, and are also well known to those of ordinary skill in the arts of computer networking and wireless communication systems.

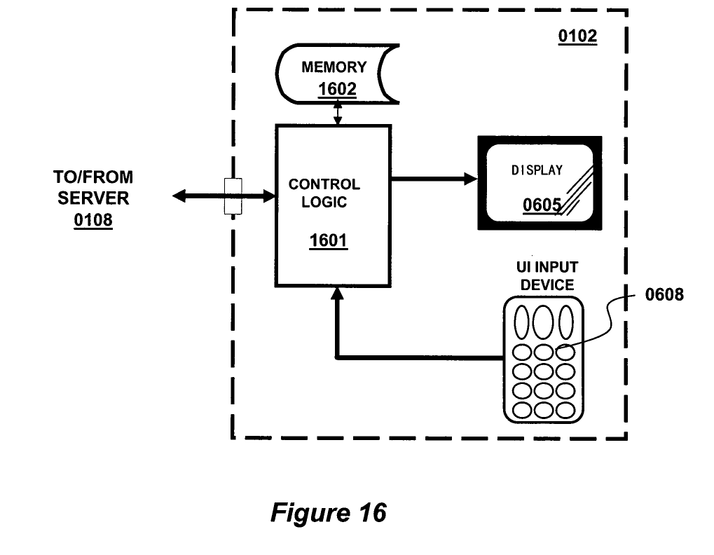

FIG. 16 illustrates an exemplary implementation of client device in accordance with one embodiment of the invention. The example provided in FIG. 16 illustrates operable linkages of control logic 1601, memory 1602, UI input device 0608, and display 0605. Memory 1602 is typically random access memory, and may be implemented in volatile and/or nonvolatile integrated circuit technologies and is used to store data such as display pages and global data. [DON: other memory.] The control logic 1601 can be a CMOS IC that implements microcontroller functions for the mobile communication device 0102 (or other client functions or features), in addition to digital signal processing and data processing, as are well known in the art. The UI engine can execute on control logic 1601. [DON: Elaborate—hardware, software, firmware, etc.]

Processor 403 process inputs from UI input device 406 and/or server 0108, to generate outputs for display via UI output device 0605, using data from memory 1602 and/or from server 0108. UI output device 0605 serves as a way to send data to a user. Examples of UI output device 0605 include electronic display screens (such as light emitting diode, LED, or liquid crystal display, LCD), visual annunciators such as LEDs or other type of lamps, sound emitters such as speakers or buzzers, and tactile stimulators, such as vibrators. UI input device 406 provides a means for users to input data to the mobile communication device. Examples of UI input devices 0608 include keypads, touch screens, and other types of tactile or audio sensors.

Table 4 list examples of visual display component along with their respective descriptions and parameter options. A display page is itself a display component, that consists of other, lower-level, display component. A variety of lower-level display components are listed that can accommodate the composition of a creative variety of client applications. In Table 4, WAP refers to the Wireless Access Protocol Standard of the Open Mobile Alliance, 4275 Executive Square, Suite 240, La Jolla, Calif. 92037. Also in Table 4, “focusable” is synonymous with selectable. It is the act of making a display component selected for editing, rather than moving between components. For example, when a text component is focused, a cursor can appear.

TABLE 4
Display Components

| Name: | Description: | Parameters | |
|---|---|---|---|
| Display page | a screen display in an | 1) | Name - name of the display page |
| | application | 2) | Version - version id of the display |
| | | | page |
| | | 3) | Caching type - different types of |
| | | | caching: |
| | | | dynamic - no caching, |
| | | | caching - cached for the session, |
| | | | store - cached permanently, |
| | | | back caching - cached during the back |
| | | | operation |
| | | 4) | Back button - whether the back button |
| | | | is enabled |
| | | 5) | Round border - whether the display |
| | | | page has round border |
| | | 6) | Ok button Height - whether the OK |
| | | | button is enabled |
| | | 7) | Home - whether or not the home |
| | | | button is enabled |
| | | 8) | Time Out - whether is timeout to a |
| | | | another display page automatically |
| | | 9) | Show animate - shows animation |
| | | | during a network call |
| | | 10) | Exit enabled - whether exit button is |
| | | | enabled |
| | | 11) | Menu items - options for user to select |
| | | 12) | Keymapper - type of key set used |
| | | | (normal dialing pad or ASCII) |
| Label | a single line of text | 1) | Name - name of the component |
| | | 2) | Type - What type of component it is |
| | | 3) | LocationX - starting X coordinate |
| | | 4) | LocationY - starting Y coordinate |
| | | 5) | Width - width of component |
| | | 6) | Height - height of component |
| | | 7) | Text Style - style of the component |
| | | | (plain, bold, small, large, medium, . . . ) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling for scrolling |
| | | | options |
| | | 13) | Panning - whether or not panning is |
| | | | supported |
| | | 14) | Relative - if screen size changes do we |
| | | | need to scale accordingly |
| | | 15) | Dynamic - is the content dynamic? |
| | | 16) | Focusable - whether or not the |
| | | | component can be focused (i.e. visually |
| | | | highlighted, usually upon selection) |
| | | 17) | Font Style - proportional, system, or |
| | | | other styles |
| | | 18) | Alignment - right, left, top, bottom |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Value - data for the label |
| Text Field | a box for user entry of | 1) | Name - name of the component |
| | a single line of data | 2) | Type - component type |
| | | 3) | LocationX - starting X coordinate |
| | | 4) | LocationY - starting Y coordinate |
| | | 5) | Width - component width |
| | | 6) | Height - component height |
| | | 7) | Text Style - plain, bold, small, large, |
| | | | medium, . . . |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling |
| | | 13) | Panning - whether or not panning is |
| | | | supported |
| | | 14) | Relative - if screen size changes do we |
| | | | need to scale the display component |
| | | | accordingly? |
| | | 15) | Dynamic - is the content dynamic? |
| | | 16) | Focusable - whether or not the |
| | | | component can be focused |
| | | 17) | Font Style - proportional, system or |
| | | | other styles |
| | | 18) | Alignment - right, left, top, bottom, |
| | | | center, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Text Field type - type of text field |
| | | | (anything, number, alphanumeric, |
| | | | email, alphabet, small alphabet, |
| | | | password) |
| | | 28) | Text field can be empty? - whether |
| | | | text field can be empty |
| | | 29) | Maximum size - maximum size of the |
| | | | text field size |
| | | 30) | Value - data for the label |
| Text Area | a scrollable box for | 1) | Name - name of the component |
| | user entry of multiple | 2) | Type - what type of component it is |
| | lines of data | 3) | LocationX - starting X coordinate |
| | | 4) | LocationY - starting Y coordinate |
| | | 5) | Width - width of component |
| | | 6) | Height - height of component |
| | | 7) | Text Style - style of the component |
| | | | (plain, bold, small, large, medium) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling |
| | | 13) | Panning - whether or not panning is |
| | | | supported |
| | | 14) | Relative - if the screen size changes do |
| | | | we need to scale display component |
| | | | accordingly |
| | | 15) | Dynamic - is the content dynamic? |
| | | 16) | Focusable - whether the component |
| | | | can be focused |
| | | 17) | Font Style - proportional, system, or |
| | | | other styles |
| | | 18) | Alignment - right, left, top, or bottom |
| | | | aligned |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Maximum size - maximum size of the |
| | | | text field size |
| | | 28) | Value - data for the label |
| Message Area | a scrollable text | 1) | Name - name of the component |
| | display box | 2) | Type - what type of component it is |
| | | 3) | LocationX - starting X coordinate |
| | | 4) | LocationY - starting Y coordinate |
| | | 5) | Width - width of component |
| | | 6) | Height - height of component |
| | | 7) | Text Style - style of the component |
| | | | (plain, bold, small, large, medium, . . . ) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling |
| | | 13) | Panning - whether or not panning is |
| | | | supported |
| | | 14) | Relative - if screen size changes do we |
| | | | need to scale the display component |
| | | | accordingly? |
| | | 15) | Dynamic - is the content dynamic? |
| | | 16) | Focusable - whether or not the |
| | | | component can be focused |
| | | 17) | Font Style - proportional, system or |
| | | | other styles |
| | | 18) | Alignment - right, left, top, bottom, |
| | | | center, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Value - data for the label |
| Choice Box | an icon that can be | 1) | Name - name of the component |
| | selected by a user to | 2) | Type - what type of component it is |
| | indicate a choice from | 3) | LocationX - starting X coordinate |
| | a list of choices | 4) | LocationY - starting Y coordinate |
| | | 5) | Width - width of component |
| | | 6) | Height - height of component |
| | | 7) | Text Style - Style of the component |
| | | | (plain, bold, small, large, medium, . . . ) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support circular, back and |
| | | | forth, reset, or no rolling |
| | | 13) | Panning - whether or not panning is |
| | | | supported |
| | | 14) | Relative - if the screen size changes do |
| | | | we need to scale accordingly |
| | | 15) | Dynamic - is the content dynamic? |
| | | 16) | Focusable - Whether the component |
| | | | can be focused |
| | | 17) | Font Style - proportional, system, or |
| | | | other styles |
| | | 18) | Alignment - right, left, top, bottom, |
| | | | centered, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Items - list of values |
| | | 28) | Default selection - the default selection |
| | | | of the choice box |
| | | 29) | Arrange - whether to arrange text |
| | | | items alphabetically or not |
| Choice Group | a group of options | 1) | Name - name of the component |
| | with, each with a | 2) | Type - What type of component it is |
| | selection status display | 3) | LocationX - starting X coordinate |
| | | 4) | LocationY - starting Y coordinate |
| | | 5) | Width - width of component |
| | | 6) | Height - height of component |
| | | 7) | Text Style - Style of the component |
| | | | (plain, bold, small, large, medium, . . . ) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling |
| | | 13) | Panning - whether supports panning or |
| | | | not |
| | | 14) | Relative - if screen size changes do we |
| | | | need to scale the display component |
| | | | accordingly? |
| | | 15) | Dynamic - Is the content dynamic? |
| | | 16) | Focusable - Whether the component |
| | | | can be focused |
| | | 17) | Font Style - proportional, system, or |
| | | | other styles |
| | | 18) | Alignment - right, left, top, bottom, |
| | | | center, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Number of selection - maximum |
| | | | number of selections allowed |
| | | 28) | Pairvalues - items having an associated |
| | | | selected or a non selected state |
| List | a list of items from | 1) | Name - name of the component |
| | which a user may | 2) | Type - What type of component it is |
| | make a selection | 3) | LocationX - starting X coordinate |
| | | 4) | LocationY - starting Y coordinate |
| | | 5) | Width - width of component |
| | | 6) | Height - height of component |
| | | 7) | Text Style - style of the component |
| | | | (plain, bold, small, large, medium, . . . ) |
| | | 8) | Value type - redundant |
| | | 9) | Language - English or other natural |
| | | | language |
| | | 10) | Fill border - whether has a border |
| | | 11) | Border Size - border size |
| | | 12) | Rolling support - circular, back and |
| | | | forth, reset, or no rolling |
| | | 13) | Panning - whether or not panning is |
| | | | supported |
| | | 14) | Relative - if screen size changes do we |
| | | | scale display component accordingly? |
| | | 15) | Dynamic - is the content is determined |
| | | | dynamically? |
| | | 16) | Focusable - whether the component |
| | | | can be focused |
| | | 17) | Font Style - proportional, system or |
| | | | other styles |
| | | 18) | Alignment - right, left, top, bottom, |
| | | | centered, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Scroll color - color of the scrolling bar |
| | | 28) | Action to activate - what type of action |
| | | | to activate when a user selects it (e.g. |
| | | | data call, voice call, SMS, ring tone, |
| | | | wallpaper, . . . ) |
| | | 29) | ListType - type of list (image, |
| | | | complex, static, dynamic, . . . ) |
| | | 30) | Is continues - whether or not the list is |
| | | | continuous |
| | | 31) | Auto Fire - fire event is enabled when |
| | | | a item is selected or not (a fire event is |
| | | | a timing critical event, such as a call to |
| | | | a server |
| | | 32) | Exit point - whether continuous exit |
| | | | point are in list or not |
| | | 33) | Items - list items |
| Image | a bitmapped image | 1) | Name - name of the component |
| | | 2) | Type - what type of component it is |
| | | 3) | LocationX - starting X coordinate |
| | | 4) | LocationY - starting Y coordinate |
| | | 5) | Width - width of component |
| | | 6) | Height - height of component |
| | | 7) | Fill border - whether has a border |
| | | 8) | Border Size - border size |
| | | 9) | Rolling support - circular, back and |
| | | | forth, reset or no rolling |
| | | 10) | Panning - whether or not panning is |
| | | | supported |
| | | 11) | Relative - if screen size changes do we |
| | | | need to scale the display component |
| | | | accordingly? |
| | | 12) | Dynamic - is the content dynamic? |
| | | 13) | Focusable - whether the component |
| | | | can be focused |
| | | 14) | Alignment - right, left, top, bottom, |
| | | | center, . . . |
| | | 15) | Background color - background color |
| | | 16) | Background focus color - background |
| | | | color when focused |
| | | 17) | Border color - border color |
| | | 18) | Border focus color - border color when |
| | | | focused |
| | | 19) | WAP row ID - component row for |
| | | | WAP |
| | | 20) | WAP column ID - component column |
| | | | for WAP |
| | | 21) | Image - image name |
| | | 22) | Photo album - whether it is part of a |
| | | | photo album or not |
| Button Image | a pair of images: one | 1) | Name - name of the component |
| | focused, the other | 2) | Type - what type of component it is |
| | blurred | 3) | LocationX - starting X coordinate |
| | | 4) | LocationY - starting Y coordinate |
| | | 5) | Width - width of component |
| | | 6) | Height - height of component |
| | | 7) | Fill border - whether has a border |
| | | 8) | Border Size - border size |
| | | 9) | Rolling support - circular, back and |
| | | | forth, reset, or no rolling |
| | | 10) | Panning - whether or not panning is |
| | | | supported |
| | | 11) | Relative - if screen size changes do we |
| | | | need to zoom |
| | | 12) | Dynamic - is the content dynamic? |
| | | 13) | Focusable - whether or not the |
| | | | component can be focused |
| | | 14) | Alignment - right, left, top, bottom, |
| | | | center, . . . |
| | | 15) | Background color - background color |
| | | 16) | Background focus color - background |
| | | | color when focused |
| | | 17) | Border color - border color |
| | | 18) | Border focus color - border color when |
| | | | focused |
| | | 19) | WAP row ID - component row for |
| | | | WAP |
| | | 20) | WAP column ID - component column |
| | | | for WAP |
| | | 21) | Image - image name |
| | | 22) | FocusImage - image name when |
| | | | focused |
| Hotspot | component with | 1) | Name - name of the component |
| | images from which | 2) | Type - what type of component it is |
| | user may select one | 3) | LocationX - starting X coordinate |
| | | 4) | LocationY - starting Y coordinate |
| | | 5) | Width - width of component |
| | | 6) | Height - height of component |
| | | 7) | Text Style - Style of the component |
| | | | (plain, bold, small, large, medium, . . . ) |
| | | 8) | Value type - redundant |
| | | 9) | Language - English or other national |
| | | | language |
| | | 10) | Fill border - whether has a border |
| | | 11) | Border Size - border size |
| | | 12) | Rolling support - Circular, back and |
| | | | forth, reset or no rolling |
| | | 13) | Panning - whether or not panning is |
| | | | supported |
| | | 14) | Relative - if screen size changes do we |
| | | | need to zoom |
| | | 15) | Dynamic - is the content dynamic? |
| | | 16) | Focusable - whether or not the |
| | | | component can be focused |
| | | 17) | Font Style - proportional, system, or |
| | | | other styles |
| | | 18) | Alignment - right, left, top, bottom, |
| | | | center, . . . |
| | | 19) | Foreground color - foreground color |
| | | 20) | Background color - background color |
| | | 21) | Foreground focus color - foreground |
| | | | color when focused |
| | | 22) | Background focus color - background |
| | | | color when focused |
| | | 23) | Border color - border color |
| | | 24) | Border focus color - border color when |
| | | | focused |
| | | 25) | WAP row ID - component row for |
| | | | WAP |
| | | 26) | WAP column ID - component column |
| | | | for WAP |
| | | 27) | Exit points - list the image items |
| | | | corresponding to next display screen |
| | | | selections |
| Circle | a vector drawn circle | 1) | Name - name of the component |
| | | 2) | Type - what type of component it is |
| | | 3) | LocationX - starting X coordinate |
| | | 4) | LocationY - starting Y coordinate |
| | | 5) | Width - width of component |
| | | 6) | Height - height of component |
| | | 7) | Fill background - whether to fill or not |
| | | 8) | Round rectangle - whether borders are |
| | | | rounded or not |
| | | 9) | Foreground color - foreground color |
| | | 10) | Background color - background color |
| Square | a vector drawn | 1) | Name - name of the component |
| | rectangle | 2) | Type - what type of component it is |
| | | 3) | LocationX - starting X coordinate |
| | | 4) | LocationY - starting Y coordinate |
| | | 5) | Width - width of component |
| | | 6) | Height - height of component |
| | | 7) | Fill background - whether to fill or not |
| | | 8) | Round rectangle - whether borders are |
| | | | rounded or not |
| | | 9) | Foreground color - foreground color |
| | | 10) | Background color - background |
| Line | a vector drawn line | 1) | Name - name of the component |
| | | 2) | Type - What type of component it is |
| | | 3) | LocationX - starting X coordinate |
| | | 4) | LocationY - starting Y coordinate |
| | | 5) | Width - width of component |
| | | 6) | Height - height of component |
| | | 7) | Foreground color - foreground color |
| | | 8) | Background color - background |

definitions of user interface components without impacting the overall performance of the invention, as readily apparent to one of ordinary skill in the art.

While various embodiments of the present invention have been described above, it should be understood that they have been presented by way of example only, and not of limitation. Thus the breadth and scope of the present invention should not be limited by any of the above-described exemplary embodiments, but should be defined only in accordance with the following claims and their equivalents. Additionally, the invention is described above in terms of various exemplary embodiments and implementations. It should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives like “conventional,” “traditional,” “normal” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “an” should not be read as requiring that each and every one of those items be present in the grouping, but rather should be read as “and/or” unless expressly stated otherwise.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration. Indeed, alternative functional, logical or physical partitioning can be implemented to achieve the desired features and functionality of the present invention. Additionally, a multitude of different constituent module names other than those depicted herein can be applied to the various partitions. As an additional example, with regard to flow diagrams and their accompanying description, the order in which steps may be set forth shall not be interpreted as requiring that the operations take place in that particular order unless the context dictates otherwise.

1. A method for providing rule set based applications by a first server for use by a client device in a client-server system comprising:
receiving a request for an application by the first server;
receiving at least one of a set of client device characteristics by the first server;
selecting at least one of a plurality of rule sets defining the requested application based on a similarity of the received at least one of the set of client device characteristics to a device characteristic associated with the rule set according to the received indication by the first server; and
sending the rule set to the client device by the first server to provide an application responsive to the request.

2. The method of claim 1 wherein the set of client device characteristics comprises at least one of (i) a client device's carrier identification, (ii) a client device's software operating system identification, (iii) a client device's type identification, and (iv) a client device's screen dimensions in pixels, (v) an application identifier for the client device, and (vi) an application state indicator for the client device.

3. The method of claim 1 wherein a rule set comprises at least one of static content that changes infrequently, dynamic content that changes frequently, formatting information for displaying content on the client device, and global information for storage on a client device for repeated use by the application.

4. The method of claim 1 further comprising: selecting a first one of a plurality of meta rules based on a similarity of the received at least one of the set of client device characteristics to a device characteristic associated with the meta rule; and translating the rule set according to the meta rule by the first server to conform to the at least one of the set of client device characteristics.

5. The method of claim 4 further comprising selecting a second one of the plurality of meta rules for a second translation of the rule set.

6. The method of claim 1, further comprising: retrieving, by the first server, content from a content provider; and combining, by the first server, the retrieved content with the rule set, wherein combining comprises associating an item of retrieved content with a display component in the rule set.

7. The method of claim 6, wherein retrieving comprises requesting content from the content provider, on the basis of a content identifier associated with the rule set.

8. The method of claim 6, wherein retrieving comprises requesting content from the content provider, on the basis of a content identifier associated with a content adapter of the first server.

9. The method of claim 6, wherein content comprises at least one of static content and dynamic content.

10. The method of claim 6, wherein content provider comprises a second server.

11. The method of claim 6, wherein the first and second servers are communicatively connected by a computer network.

12. The method of claim 1, further comprising: converting, by the first server, the received indication from a first data format to a second data format for subsequent processing by the server; and converting, by the server, the translated rule set from the second data format to the first data format, prior to sending the translated rule set to the client.

13. The method of claim 12, wherein the first data format comprises at least one of HTML, XML, and WML.

14. The method of claim 1, wherein the client is a mobile communication device.

15. The method of claim 14, wherein the mobile communication device is a cellular telephone.

16. A method for selecting a rule set defining an application in a client-server system comprising: receiving, by a server from a client, an indication of client characteristics, the client characteristics comprising at least one of (i) a client's carrier, (ii) a client's software operating system, (iii) a client's device type, and (iv) a client's screen size; and selecting, by the server, a rule set corresponding to the received indication if a corresponding rule set is available; otherwise selecting a default rule set if a corresponding rule set is not available.

17. The method of claim 16 wherein the rule set is a meta rule set.

18. A method for generating a meta rule based on a client's display screen size, comprising:
receiving x_{c} and y_{c}, the horizontal and vertical dimensions in pixels, respectively, of a client's screen;
receiving xᵣ and yᵣ, the vertical and horizontal dimensions in pixels, respectively, of a reference screen from a rule set;
calculating a scaling factor based on at least one of the ratio of x_{c}/xᵣ and the ratio y_{c}/yᵣ; and
scaling designated display components of the rule set by the scaling factor.

19. The method of claim 18 wherein the scaling factor is 2−x_{c}/xᵣ+y_{c}/y_{r.}
